(19) United States
(12) Patent Application Publication
(10) Pub. No.: US 2025/0389255 A1
(43) Pub. Date: Dec. 25, 2025

(54) WIND TURBINE TOWER AND CARRIAGE

(71) Applicant: SENSE Wind Limited, Bury St Edmunds (GB)

(72) Inventors: Patrick Geraets, Bury St Edmunds (GB); Christopher Hornzee-Jones, Brighton (GB); Luiz Eduardo da Silva Demenicis, London (GB)

(21) Appl. No.: 18/879,175

(22) PCT Filed: Jun. 27, 2023
(86) PCT No.: PCT/GB2023/051681

§ 371 Date: Dec. 26, 2024

(30) Foreign Application Priority Data
Jun. 27, 2022 (GB) 2209412.2

(51) Int. Cl. F03D 13/10

(52) U.S. Cl. CPC F03D 13/116; F05B 2230/61

(57) ABSTRACT

A wind turbine tower elevator carriage for clamping onto at least a first tower rail extending up a wind turbine tower to releasably support the carriage on the first tower rail, the elevator carriage comprising: a carriage body, independently operable first and second releasable rail clamps and a lifting mechanism for raising and lowering the carriage body with respect to the first releasable rail clamp.

This application is a U.S. national phase application under 35 U.S.C. § 371 of international application number PCT/GB2023/051681 filed on Jun. 27, 2023, which claims the benefit of GB application number 2209412.2 filed on Jun. 27, 2022. The entire contents of each of international application number PCT/GB2023/051681 and GB application number 2209412.2 are incorporated herein by reference.

### TECHNICAL FIELD

The present disclosure relates to a wind turbine assembly, a wind turbine tower elevator carriage, a method of assembling a wind turbine tower, and a wind turbine tower.

### BACKGROUND

There is a requirement for an improved wind turbine assembly, wind turbine tower, elevator carriage and wind turbine assembly method.

### SUMMARY

According to a first aspect, there is provided a wind turbine tower elevator carriage for clamping onto at least a first tower rail extending up a wind turbine tower to releasably support the carriage on the first tower rail, the elevator carriage comprising: a carriage body, independently operable first and second releasable rail clamps and a lifting mechanism for raising and lowering the carriage body with respect to the first releasable rail clamp.

According to a second aspect, there is provided a method of assembling a wind turbine tower having a tower body and a rail extending up the tower body, wherein the tower comprises a plurality of serially connected tower sections, each tower section having a respective tower body section and respective section of the rail, wherein the method comprises: erecting a first tower section; providing an elevator carriage on the rail of the first tower section; loading a second tower section onto the elevator carriage, when the elevator carriage is in a first position; transporting the second tower section by raising the elevator carriage up the rail to a second position, wherein the second position is higher than the first position; using the elevator carriage to transfer the second tower section onto the first tower section; and connecting the second tower section to the first tower section.

According to a third aspect, there is provided a wind turbine tower having tower body and a rail extending up the tower body; wherein the rail has an outer face S1 orientated away from the tower body and opposed sides S2, S3, S4 connecting the outer face S1 to the tower body; wherein each of the opposed sides has a channel CH extending along the rail, the channel comprising a clamping face S2 adjacent a first bearing face S3; wherein the clamping faces S2 of the opposed sides are parallel to a central plane CP extending outwardly from the tower body through the middle of the width B of the base of the rail at the tower body; and wherein for each opposed side, the first bearing face S3 is tilted towards the clamping face S2, being angled with respect to the central plane CP by a first angle of 30° to 60°.

According to a fourth aspect, there is provided a wind turbine tower having a tower body and three or more rails extending up the tower body; wherein the centres of adjacent rails are spaced apart around the centre of the tower body by at least 80° or by a straight-line separation of at least 2 m (e.g. a separation of at least 2 m between the centres of the adjacent rails).

According to a fifth aspect, there is provided a wind turbine tower assembly comprising: a wind turbine tower; a fixed-level access platform; and a variable-level access platform configured to form an access platform assembly that extends fully around the wind turbine tower.

The elevator carriage may comprise a nacelle support for supporting a wind turbine nacelle in a nacelle elevation position whilst the elevator carriage ascends the wind turbine tower.

The elevator carriage may comprise a carriage chassis and the nacelle support is pivotable with respect to the carriage chassis about a substantially vertical axis, when the elevator carriage is mounted onto the side of a wind turbine tower.

The nacelle support may be provided with a nacelle transfer mechanism for transferring the wind turbine nacelle from the nacelle elevation position to the top of the wind turbine tower. The elevator carriage may comprise a tower section support for supporting a wind turbine tower section in a tower section elevation position whilst the elevator carriage ascends the wind turbine tower.

The tower section support may be provided with a tower section transfer mechanism for transferring the wind turbine tower section from the tower section elevation position to the top of the wind turbine tower.

Each releasable rail clamp may comprise: a rail clamp body; opposed rail clamping pads for clamping onto the rail; and a pad actuator; wherein a rail clamping pad is a wedge-shaped pad, having a first pad surface for contacting the rail and an opposed second pad surface received in a complementarily shaped shoe, wherein the second pad surface is not parallel with the first pad surface; and the pad actuator is operable to move the wedge-shaped pad relative to the shoe and substantially parallel to the length of the rail.

The opposed rail clamping pads of the releasable rail clamp may each be a wedge-shaped pad, having a first pad surface for contacting the rail and an opposed second pad surface received in a complementarily shaped shoe, wherein the second pad surface is not parallel with the first pad surface; and the pad actuator may be operable to move the opposed wedge-shaped pads relative to the shoes and substantially parallel to the length of the rail.

The rail clamp may comprise: a clamp chassis with opposed clamp arms supporting respective rail clamping pads; and a clamp pivot actuator; and the clamp pivot actuator is operable to pivot a clamp arm relative to the opposed clamp arm between an open and a closed configuration.

The clamp arm may be provided with a releasable self-locking linkage for retaining the clamp arm in a clamped position.

The clamp pivot actuator may be operable to pivot the clamp arms with respect to the clamp chassis, between the open and closed configurations.

The clamp chassis may have a base for bearing against a bearing surface of the rail.

Each releasable rail clamp may comprise a repeating assembly of rail clamp modules.

The carriage body may be provided with a carriage sliding bearing for engagement with a first tower rail extending up the wind turbine tower.

The elevator carriage may comprise a reaction arm (e.g. an articulated carriage arm) connected to the carriage body, and the reaction arm may comprise a lateral bearing assembly and a bearing arm actuator for engaging the lateral bearing assembly with the wind turbine tower.

The lateral bearing assembly may comprise a first bearing member for engaging with the exterior surface of the tower body of the wind turbine tower.

The lateral bearing assembly may comprise a second bearing member for engaging with a second tower rail of the wind turbine tower.

The second bearing member may be configured to engage against a side of the second tower rail proximate the first tower rail.

The second bearing member may be configured to releasably receive the second tower rail into the second bearing member.

The reaction arm may comprise one or more extendible arm members for changing the separation between the carriage body and the lateral bearing assembly.

The elevator carriage may comprise opposed reaction arms (e.g. opposed articulated carriage arms).

The elevator carriage may comprise upper and lower primary sliding bearings.

Transferring the second tower section onto the first tower section may comprise sliding the second tower section into alignment with the first tower section.

Transferring the second tower section onto the first tower section may comprise pivoting the second tower section into alignment with the first tower section about a vertical axis.

The method may further comprise: loading a wind turbine nacelle onto the elevator carriage in a third position; raising the elevator carriage to a fourth position; using the elevator carriage to transfer the nacelle onto the top of the wind turbine tower; and connecting the nacelle to the top of the wind turbine tower.

Each of the opposed sides of the rail may further comprise a second bearing face S4, with the clamping face S2 between the first bearing face S3 and the second bearing face S4, wherein for each opposed side, the second bearing face S4 is tilted towards the clamping face S2, being angled with respect to the central plane CP by a second angle of 30° to 60°.

The tower may comprise three or more rails extending up the tower, wherein the rails are spaced apart around the tower in a rotationally symmetric arrangement.

The centres of adjacent rails may be spaced apart around the centre of the tower body by at least 80°. The centres of adjacent rails may be spaced apart around the centre of the tower body by at least 90°.

The wind turbine tower may have three rails, and the centres of adjacent rails may be spaced apart around the centre of the tower body by 100° to 160°. The centres of adjacent rails may be spaced apart around the centre of the tower body by 110° to 140°.

The centres of the rails may be spaced apart around the centre of the tower body in a rotationally symmetric arrangement.

The tower may comprise a tower body with an exterior surface having a circular cross-sectional shape, and rails that project from the exterior surface of the tower body.

Each rail may have an outer face S1 orientated away from the tower body and opposed sides S2, S3, S4 connecting the outer face to the tower body; wherein each of the opposed sides has a channel CH extending along the rail, the channel comprising a clamping face S2 adjacent a first bearing face S3; wherein the clamping faces S2 of the opposed sides are parallel to a central plane (CP) extending outwardly from the tower body through the middle of the width (B) of the base of the rail at the tower body; and wherein for each opposed side, the first bearing face S3 is tilted towards the clamping face S2, being angled with respect to the central plane CP by a first angle of 30° to 60°.

The rail may be hollow.

The rail may comprise an internal stiffener bracing between the clamping surfaces and extending up the tower.

The rail may be welded to the tower body along the length of the rail.

The tower may have a tower body that is tubular.

The tower body may comprise a plurality of serially connected tower body sections, and wherein each rail comprises a corresponding plurality of rail sections provided on respective tower body sections.

The wind turbine tower may have a tower body and a rail extending up the tower body, the wind turbine tower may have an elevator carriage configured to engage with the rail for raising and lowering the elevator carriage up the wind turbine tower, and the variable-level access platform may be configured to form a releasable connection with the elevator carriage for raising and lowering the variable-level access platform.

The wind turbine tower may have a tower body and a rail extending up the tower body, and the variable-level access platform may comprise a platform drive mechanism for engaging with the rail for raising and lowering the variable-level access platform.

The variable-level access platform may be configured for mounting on the wind turbine tower, comprising releasably connecting the variable-level access platform to the fixed-level access platform.

### BRIEF DESCRIPTION OF THE DRAWINGS

Examples are further described hereinafter with reference to the accompanying drawings.

FIG. 1 shows a wind turbine assembly.

FIGS. 2A to 2D show cut-away perspective and cross-sectional views of sections of wind turbine towers.

FIGS. 3A to 3E show cross-sectional views of tower rails.

FIG. 4 shows a cross-sectional view of a further wind turbine tower.

FIGS. 5A and 5B show views of elevator carriages.

FIG. 5C shows a further carriage chassis before releasable connection onto the tower.

FIGS. 5D and 5E show the carriage chassis of FIG. 5C releasably connected onto the tower in respective first and second configurations.

FIGS. 5F shows a side view of an elevator carriage clamped onto an erected tower section.

FIG. 5G shows a perspective view of an elevator carriage.

FIGS. 6A to 6E show views of a bearing mechanism.

FIGS. 7A to 7G show views of a clamping mechanism.

FIGS. 8A to 8C show jacking an elevator carriage.

FIGS. 9A to 9K show stages in a tower assembly method.

FIG. 9L shows a perspective view of a carriage adaptor.

FIGS. 10A to 10C show a further tower assembly method.

FIGS. 11A shows a perspective view of a further carriage adaptor.

FIG. 11B shows a cut-away perspective view of a further section of a wind turbine tower.

FIG. 11C to 11D show a plan view of the carriage adaptor of FIG. 11B in use with the further section of wind turbine tower of FIG. 11A.

FIGS. 12A to 12D show the wind turbine tower with a variable-level access platform at different heights.

### DETAILED DESCRIPTION

In the described examples, like features have been identified with like numerals, albeit in some cases having one or more of: increments of integer multiples of 100; suffix letters; and typographical marks (e.g., primes). For example, in different figures, 120, 120′, 120″ and 120″′ have been used to indicate a wind turbine tower rail.

The present application describes an improved method for assembling a wind turbine and associated components used in that assembly.

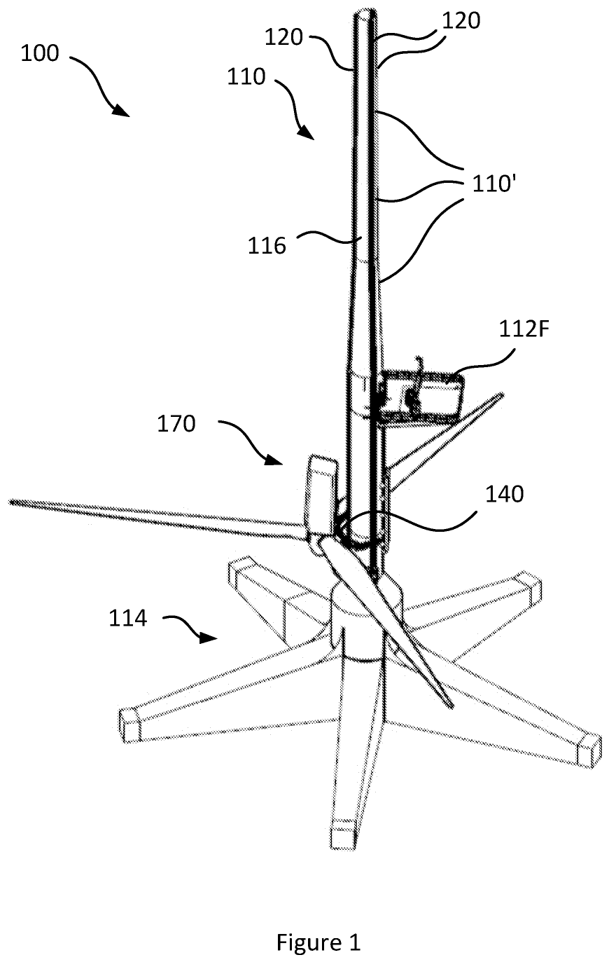

FIG. 1 illustrates a partially assembled wind turbine assembly 100, during assembly. A wind turbine tower 110 is shown, on which an elevator carriage 140 is mounted, and the elevator carriage supports a rotor-nacelle assembly 170, ready for the rotor-nacelle assembly to be raised to the top of the tower. The illustrated wind turbine assembly 100 also has an optional fixed-level access platform 112, for example, for worker access during assembly, inspection and maintenance, and/or for providing access to an access doorway (e.g., a hatch) into the interior of the wind turbine tower 110 (which may be used in offshore wind turbine assemblies and/or may be omitted from onshore wind turbine assemblies in some examples).

The illustrated wind turbine assembly 100 includes a floating foundation 114 secured to the sea floor, e.g. a PelaStar™ tension leg platform (TLP). However, the present wind turbine assembly is not limited to floating foundations. For example, the wind turbine may alternatively be mounted on an onshore or offshore hard-standing, or mounted on an alternative buoyant foundation.

The tower 110 has a tower body 116 with one or more tower rails 120 extending up the exterior of the tower body. The rail(s) 120 extend along the length (vertical in the erected tower) of the tower 110. For example, the rail(s) may extend along substantially the entire length of the tower (being the length above the foundation or as a proportion of the length of tower above sea level in the case of an offshore wind turbine), or at least 90% of the length of the tower, or at least 75% of the length of the tower, or at least 40% of the length of the tower. The tower body 116 may be hollow, e.g., generally tubular. For example, where only a portion of the tower has a tower body that is tubular, the one or more rails may extend along substantially the length of the tubular portion of the tower body, or may extend along at least 90% of the length of the tubular portion of the tower body.

Where the tower 110 has a plurality of tower rails 120, the rails are widely spaced apart around the outside the tower body 116. The centres of adjacent rails 120 are spaced apart around the centre of the tower body by at least 80° (e.g., at least 90°) or by a straight-line separation of at least 2 m. The tower body may have a diameter (or horizontal width) of at least 2.3 m. Being widely spaced apart enables substantial horizontal torques to be applied to adjacent rails without damaging the tower body 116. As shown in FIG. 1, three rails 120 may be provided. With respect to the central axis of the tower body 116, in the wind turbine assembly 100 of FIG. 1, the centres of the three rails 120 are generally equally spaced apart around the tower body 116, in a substantially rotationally symmetric arrangement, at 120° intervals (e.g. a three-fold rotationally symmetric arrangement).

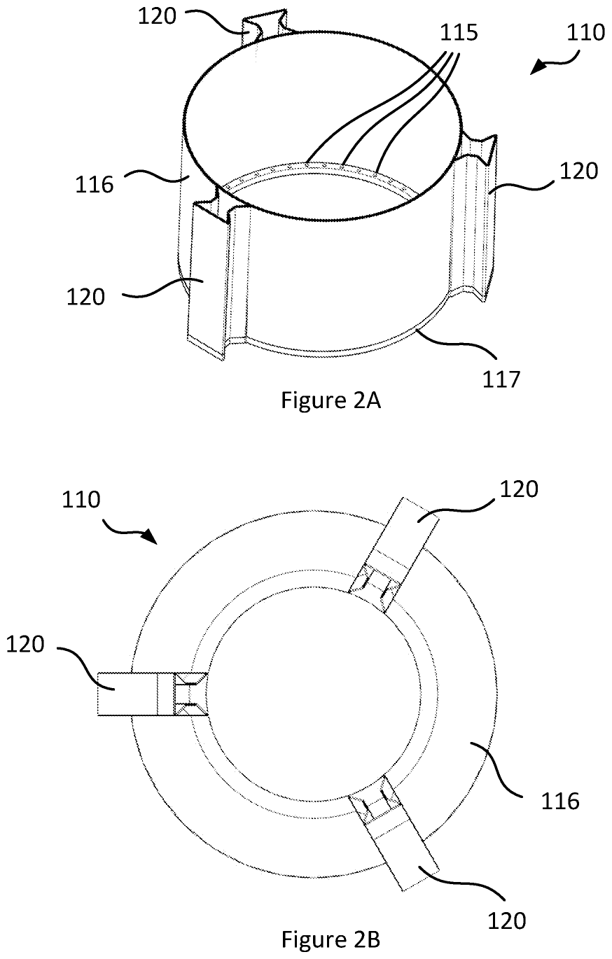

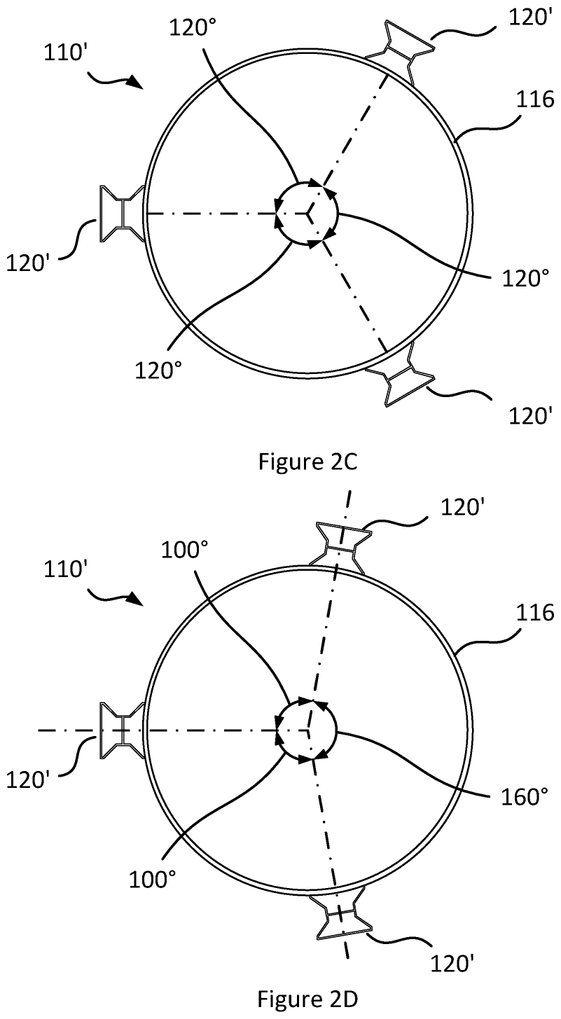

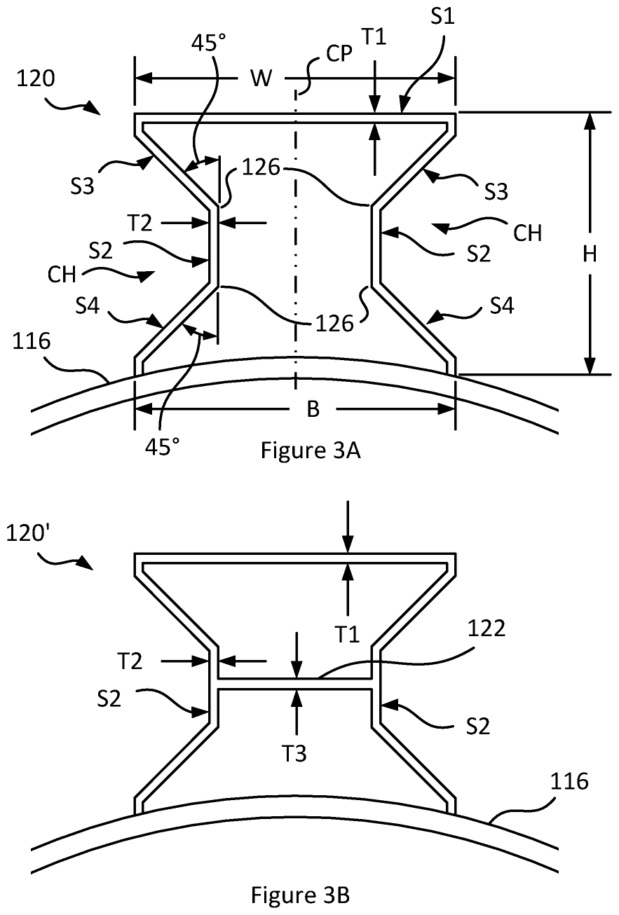

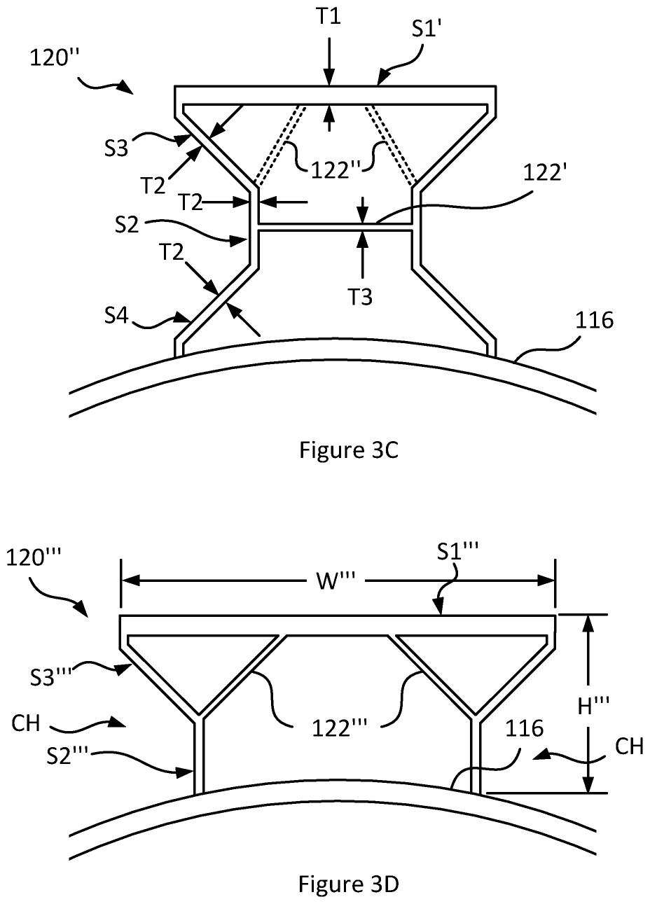

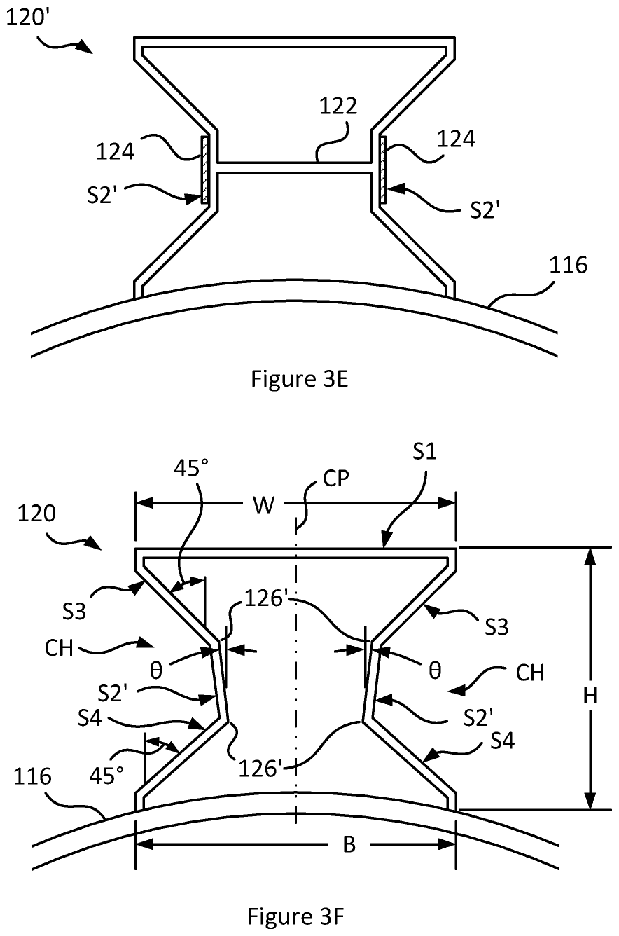

FIG. 2A shows the arrangement of the rails 120 in a perspective view of a cut-away section of tower 110, and FIG. 2B shows the arrangement of rails in an axial view down onto a cut-away tower (e.g. a vertical view of an erected tower). FIG. 2C shows a cross-sectional view through a tower 110 with a corresponding arrangement of rails 120′ of a second design, as discussed further in relation to FIG. 3B.

The rails 120 are connected to the tower body 116 along their length. For example, each rail is continuously welded to the tower body along the length of the rail, or in the case of a multi-section tower, each rail section is welded along its length to the respective tower body section. Alternatively, each rail may be connected to the tower body along the length of the rail, or in the case of a multi-section tower, each rail section may be connected along its length to the respective tower body section, using connections, such as bolts, rivets or screws.

As well as providing a track for an elevator carriage 140 to travel along, the arrangement of rails 120 around the tower body 116 provides structural reinforcement of the tower body against lateral forces and torques, both during assembly and when the wind turbine assembly is in use. Lateral forces acting upon the tower 110 and lateral vibration of the tower arise from the effect of the wind upon the wind turbine assembly and the tower, in use. Additionally, during self-assembly, substantial forces arise when the elevator carriage 140 is used on the exterior of the tower body 116, in particular when it supports a rotor-nacelle assembly 170, as shown in FIG. 1. The reinforcement of the tower body 116 by an arrangement of reinforcing rails 120, which are spaced apart around the tower body (by at least 80° or by at least 2 m) enables the tower 110 to be constructed with a lower requirement for tower body strength, enabling the tower body to have less mass than would otherwise be required (and may enable the tower body to be narrower than would otherwise be required). The tower body may be formed from steel with a thickness of up to 100 mm. The tower body may have a minimum thickness of 12 mm.

Although in FIGS. 1 to 2C the tower rails 120 are arranged around the tower body 116 in a rotationally symmetric arrangement (at 120° intervals), alternatively, the rails may be offset from a rotationally symmetric arrangement to a limited extent. In the case of three rails, with respect to a first rail, the centres of the second and third rails may deviate from a rotationally symmetric arrangement (with respect to the first rail) by up to 20°, or up to 10°. FIG. 2D illustrates an exemplary alternative arrangement of three rails 120′, in which the centres of the second and third rails are spaced apart from the first rail by 100°, around the centre of the tower body 116.

Rails 120 that are arranged around the tower body 116 in a rotationally symmetric arrangement provide structural reinforcement of the tower body, for resisting lateral forces and control of vibrational modes, with a low complexity (e.g. maintaining a vibration response that is generally rotationally symmetric). However, being offset from a rotationally symmetric arrangement to a limited extent, as described, enables a larger gap between two adjacent rails to be provided than for a completely rotational symmetric arrangement, facilitating the provision of an access doorway (e.g., a hatch) into the tower body 116 for workers to enter the tower body 116 during assembly, maintenance and disassembly. Being offset from a rotationally symmetric arrangement by only a limited extent, as described, reduces the structural reinforcement by the rails, and the mode control of the tower, by only a small extent, compared with a rotationally symmetric arrangement.

Although FIGS. 1 to 2D concern wind turbine towers having three rails, in a further alternative arrangement, four rails may be provided (e.g. on a tower having a circular or square cross-sectional shape) that are spaced apart around the tower at 90° intervals (or deviating from a rotationally symmetric arrangement by up to 20°, or up to 10°; e.g. spaced around the tower at intervals of at least 80°).

Each of the plurality of rails 120 may be substantially identical and connected to the underlying tower body 116 in a generally similar manner. The use of substantially identical rails 120 enables each rail to provide a substantially matching structural reinforcement to the underlying tower body 116.

The provision of multiple rails 120 extending up the tower 110 may enable an elevator carriage 140 to be mounted onto the tower in different angular positions around the tower. For example, in the case of an offshore wind turbine tower 110, the elevator carriage 140 may be mounted in the angular position around the circumference of the tower 110 that is most favourable for the prevailing conditions of the wind, waves and current. Alternatively, the elevator carriage 140 may be mounted into the same position on the tower 110 (onto the same tower rail) on each occasion.

In the illustrated towers 110, the tower body 116 has a generally circular exterior in cross-section, as shown in FIGS. 1 to 2D. However, the tower body may alternatively have non-circular shape, for example having a cross-sectional shape that is generally triangular, square, or other polygonal shape (e.g. hexagonal).

FIG. 3A illustrates a cross-sectional view through a rail 120, perpendicular to the length of the rail, corresponding to the rails illustrated in FIGS. 1 to 2B.

The sides of the or each rail 120 meet the tower body 116 at the base of the rail, where the (external) sides of the rail are spaced apart a base width B, which enables the rail to resist lateral (e.g. circumferential) forces.

The one or more rails 120 may be hollow. The rails may be formed from sheet material, for example plate steel (e.g. at least 6 mm thick). For example, the rail 120 shown in FIG. 3A may be formed by bending from a single sheet of material, or by welding together sheets of material, or by a combination of bending and welding. The inclusion of bends 126 between faces of the rail 120 (which extend along the rail) enhances the strength of the rail to resist buckling, in use (e.g. strength to resist forces perpendicular to the rail length).

The rails may be formed from material having a sheet thickness T1, T2 that is less than 20% of the width W of the rail (H indicates the height of the rail, being the radial extension of the rail from the tower body, and width W is perpendicular to the height H).

Being hollow enables the rails 120 to provide structural reinforcement of the tower body 116 with a mass that is much lower than for a correspondingly sized solid rail (especially being formed from a sheet material having a thickness T1, T2 that is much less than the width W of the rail). The combination of the hollow rails 120 spaced apart around the tower body 116, as described, enables the tower 110 to be constructed with greater strength than for a corresponding tower with the same mass, but with solid rails.

The rail 120 of FIG. 3A has an outer face S1 facing away from the tower body 116, and opposed sides each having a clamping face S2 between a first side bearing face (first slideway) S3 and a second side bearing face (second slideway) S4.

For each side of the rail 120, the clamping face S2 and the first and second side bearing faces S3, S4 have a concave arrangement, forming a channel CH extending along the length of the rail. The provision of separate clamping faces S2 and bearing faces S1, S3, S4 enables clamping action to be provided without risk of damaging the bearing faces and interfering with the sliding bearing action.

The formation of the sides of the rail from a plurality of adjacent faces (e.g. S2, S3, S4) that are angled relative to each other provides a stiffening effect that supports the structure of each rail, enabling the use of a thinner and lighter side wall of the tower rail.

The opposed clamping faces S2 may be substantially parallel to each other (as illustrated in FIG. 3A). The opposed clamping faces S2 may extend generally parallel to a central plane CP extending outwardly from the tower body 116 (e.g., extending perpendicular to the underlying tower body; e.g. extending radially with respect to the centre of the tower body) through the middle of the width B of the base of the rail 120, as shown in FIG. 3A. The rail 120 may be substantial mirror symmetrical with respect to the central plane CP.

In use, with the elevator carriage 140 is mounted onto one or more rails 120, a clamping mechanism (releasable rail clamp) of the elevator carriage clamps onto the opposed clamping faces S2, to support the weight of the elevator carriage and any load that it carries. The load-supporting force arises from static friction between the clamping mechanism and the rail(s), and the sheer force arising from any mechanical deformation of the clamping surfaces, which may collectively be termed “traction”. In the case that the opposed clamping faces S2 are substantially parallel, as illustrated in FIG. 3A, enables the clamping mechanism to clamp onto the clamping faces substantially without the clamping forces resolving towards or away from the tower body 116, enhancing the stability of the elevator carriage 140 on the tower 110.

Alternatively, the opposed clamping faces S2′ may diverge from each other, as illustrated in FIG. 3F. The opposed clamping faces S2′ may be angled away from parallel to the central plane CP extending outwardly from the tower body 116 (e.g. perpendicular to the underlying tower body; e.g. extending radially with respect to the centre of the tower body) through the middle of the width B of the base of the rail 120, as shown in FIG. 3F. The clamping faces S2′ may be angled θ with respect to the central plane CP by up to +25° (e.g. up to 15° or up to 10°) or by up to −25° (e.g. up to −15° or up to −10°). Even when the clamping faces S2′ are not parallel with the central plane CP, the clamping faces S2′ are angled with respect to the adjacent side bearing faces S3, S4 by at least 5°. The bends 126′ provided by the clamping faces S2′ being angled away from parallel with the adjacent side bearing faces S3, S4 enhances the strength of the rail to resist buckling, in use.

In the case that the clamping faces S2′ diverge away from the tower body 116, the clamping forces of the clamping mechanism resolve to bias the elevator carriage 140 towards the tower 110.

The outer face S1 may be perpendicular to the central plane CP extending outwardly from the tower body 116 (e.g., perpendicular to the underlying tower body; e.g., extending radially with respect to the centre of the tower body) through the middle of the width B of the base of the rail 120.

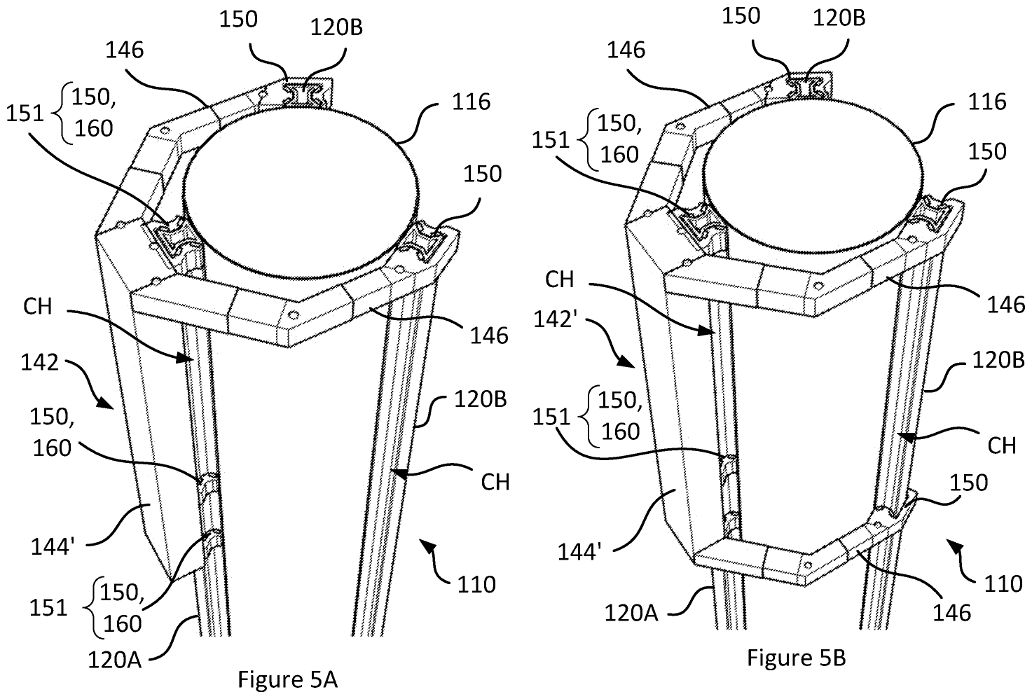

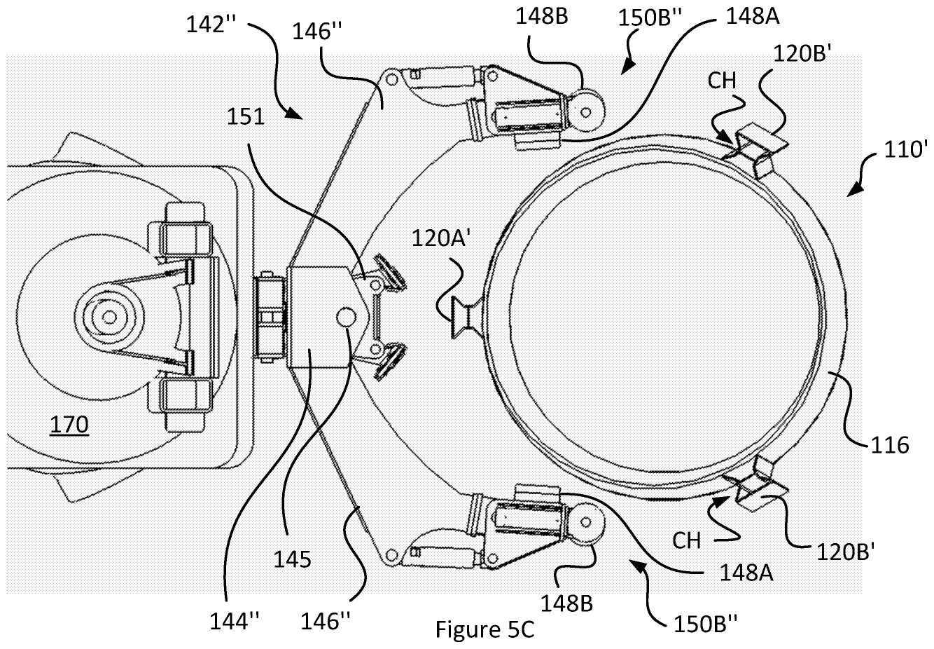

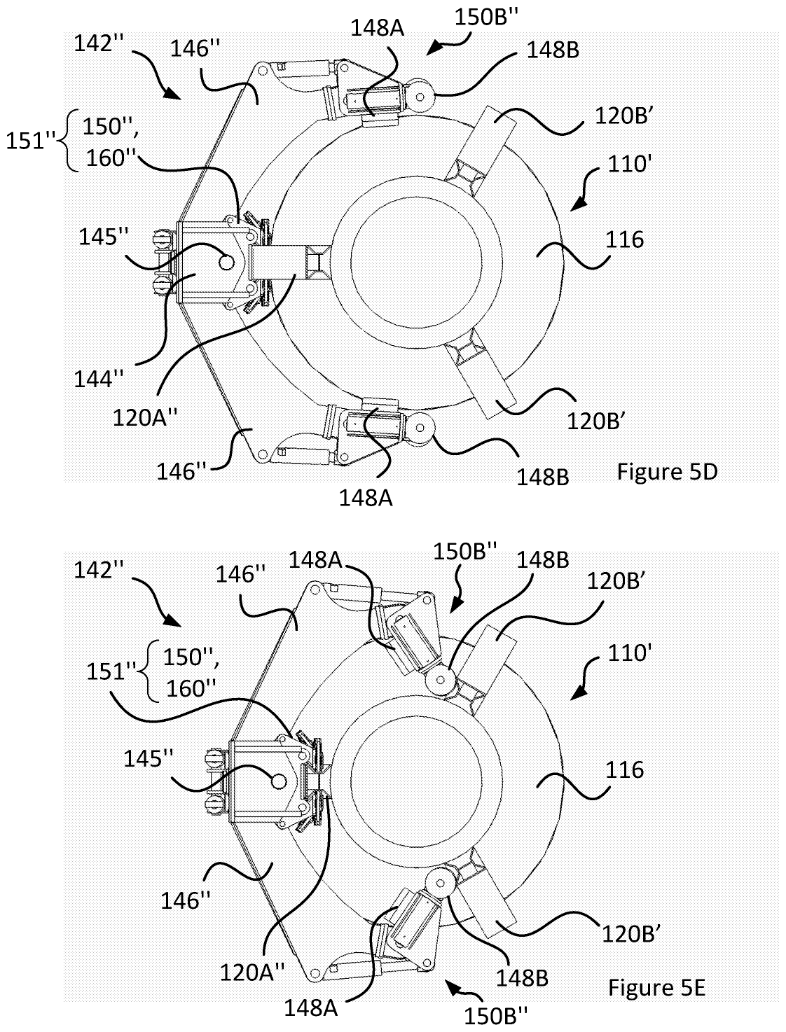

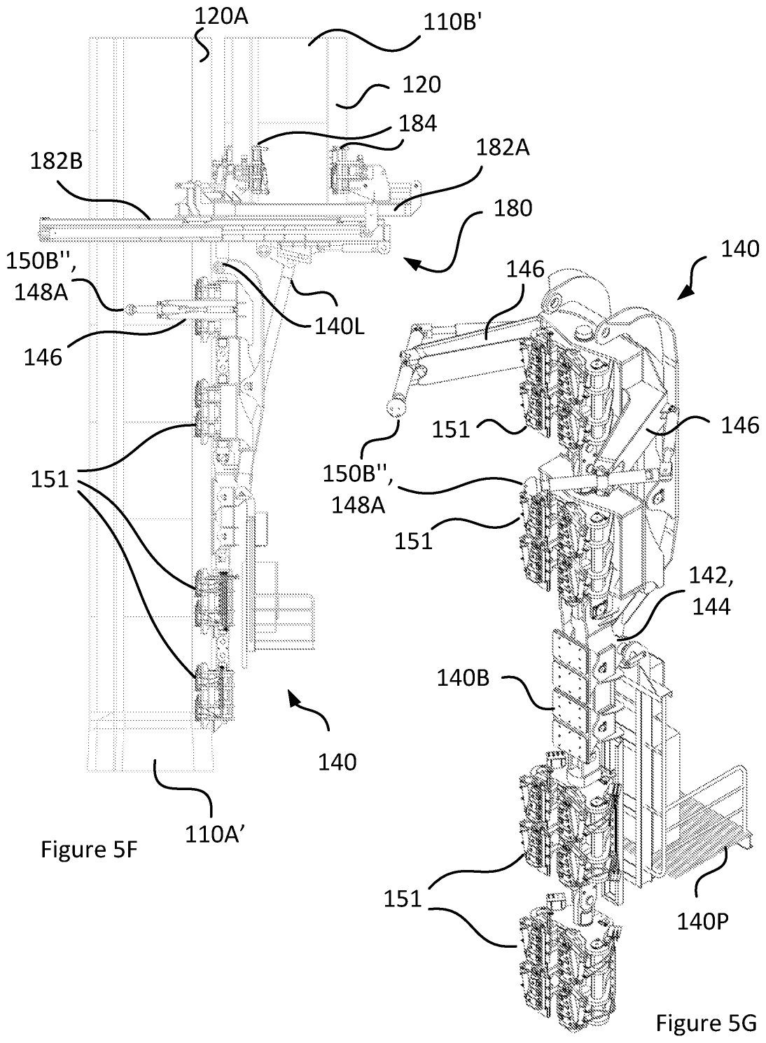

In use, the elevator carriage 140 is mounted onto one or more tower rails 120 (e.g. first tower rail 120A, 120A′ as shown in FIGS. 5A to 5E), and at least a chassis bearing assembly of the elevator carriage chassis 142 bears against at least a first tower rail. One or more lateral bearing assemblies of the elevator carriage 140 may also bear against second tower rails (120B, 120B′), either bearing against both sides of a second tower rail in a similar manner to the chassis bearing assembly as shown in FIG. 5A, or only bearing against one side of a second tower rail as shown in FIG. 5E.

At least on the first tower rail 120A, the respective bearing assembly bears against each of the first side bearing faces S3. The bearing assembly also bears against the second side bearing faces S4 providing a four-face bearing action, or the bearing assembly also bears against the outer face S1 providing a three-face bearing action (or in a further alternative the bearing assembly may bear against both the second side bearing faces S4 and the outer face S1). In the case that the bearing assembly bears against the outer face S1, the bearing assembly may be configured to bear against regions of the outer face S1 adjacent its edges (adjacent first die bearing faces S3), where the outer face S1 may be stronger, and not to bear against a central region of the outer face S1, where the outer face S1 may be less strong. The three-face or four-face bearing actions provide effective transfer of forces, in any direction, from the carriage to rails 120.

In the case that the bearing assembly bears against the first side bearing faces S3 and the second side bearing faces S4, the bearing assembly provides a strong four-face bearing action. The four-face bearing action enables the bearing and rail to resist substantially equally forces in any direction perpendicular to the length of the rail. On each side, the illustrated first bearing surfaces S3 are angled at approximately 45° to the central plane CP (e.g., also at approximately 45° to the outer surface S1). Alternatively, the first bearing surfaces S3 may be angled at 30° to 60° to the central plane CP. The provision of the second side bearing faces S4 provides the rail 120 with a wider base adjacent the tower body 116, which may enhance the distribution of force and torque from the rail to the tower body 116.

The hollow rail may additionally be provided with a transverse internal stiffener (extending transversely to the radial direction of the tower body and perpendicular to the length of the rail, e.g., substantially circumferential to the tower body 116). The provision of the internal stiffener may enhance the strength of the rail, e.g. to resist clamping forces of the elevator carriage. The provision of the internal stiffener may enable the rail to be formed with less mass than a corresponding rail of the same strength without the internal stiffener.

As shown in FIG. 3B, the hollow rail 120′ may be provided with an internal stiffener 122 extending between the opposed clamping faces S2. An internal stiffener 122 extending between the clamping faces S2 of the rail 120′ (e.g., opposed clamping faces or other clamping faces) enhances the strength of the rail to better withstand clamping forces from the clamping mechanism of the elevator carriage 140 and to better withstand lateral forces from supporting the elevator carriage (e.g., torques arising from the elevator carriage supporting a load and wind exposure upon the elevator carriage and any load), in use.

As shown in FIG. 3B, the internal stiffener may be formed from the same thickness T3 of material as the thickness T2 of at least the sides of the rail 120′. Alternatively, the internal stiffener 122′ may be formed from a material that is less thick T3 than the thickness T2 of the sides of the rail 120″, as shown in FIG. 3C. The use of a thinner T3 internal stiffener 122′ enables the rail 120″ to be formed with a reduced weight.

As shown in FIG. 3B, the outer face S1 may be formed from the same thickness T1 of material as the thickness T2 of at least the sides (at least clamping faces S2) of the rail 120′. Alternatively, the outer face S1′ may be formed from a material that is thicker T1 than the thickness T2 of the sides of the rail 120″, as shown in FIG. 3C. The use of a thicker T1 material for the outer face S1′ enables the rail 120″ to be formed with sides of a lesser thickness T2, enabling the rail to be formed with a reduced weight.

The outer face S1 and side walls (clamping face S2, first bearing surface S3, and second bearing surface S4 where present) may each have a thickness T1, T2 of at least 12 mm.

In the case that the bearing assembly bears against the first side bearing faces S3 and the outer face S1, the bearing assembly provides a strong three-face bearing action. For three-face bearing action, as shown in FIG. 3D, the rail 120″′ may omit the second side bearing faces S4, again forming a channel CH along the side of the rail 120″′.

The rail 120″′ may have a width W″′ of the outer face S1 that is significantly greater than the height H′″ (e.g. at least 50% greater), which may enhance the distribution of force and torque from the rail to the tower body 116.

As shown in FIG. 3D, the hollow rail 120″′ may (additionally or alternatively) be provided with diagonal internal stiffeners 122″′ extending between the sides of the rail and the outer face S1″′, which enhance the strength of the rail to withstand clamping forces from the clamping mechanism and lateral forces from the elevator carriage 140 (e.g. bearing forces from a bearing assembly of the elevator carriage 140), in use.

The transverse internal stiffeners 122, 122′ of FIGS. 3B and 3C may additionally or alternatively be provided to the diagonal internal stiffeners 122″′ of FIG. 3D. The diagonal internal stiffeners 122″′ of FIG. 3D may additionally or alternatively be provided to the transverse internal stiffeners 122, 122′ of FIGS. 3B, as indicated by the optional internal stiffeners 122″ shown in dashed format in FIG. 3C, which enhance the strength of the rail 120″ to withstand clamping forces on surfaces S1′ and S3, as well as resisting bending of the rail under lateral forces.

The rail and tower body may be painted or coated (e.g. zinc coating) for protection against corrosion. However, in use, the clamping mechanism applies high forces onto the clamping faces S2 of the rail, which may damage the paint on the painted rail, leading to corrosion, if not re-painted after use.

The clamping faces S2 of each rail may each be provided with a corrosion-resistant reinforcing strip 124 that extends along the length of the rail, as shown in FIG. 3E. The reinforcing strip 124 may be formed from stainless steel, weathering steel (e.g. COR-TEN® steel) or a high-strength polymer. The provision of the corrosion-resistant reinforcing strip 124 protects the clamping faces S2 during use, without the requirement to be repainted to protect against corrosion after use.

The described rails enable the elevator carriage 140 to securely connect onto one or more of the rails with a three-or four-face sliding bearing action and a weight-supporting clamping mechanism.

The elevator carriage 140 releasably connects onto at least a first tower rail 120A (e.g. a carriage chassis 142 connecting onto a first tower rail) and has one or more carriage arms 146 (e.g., one or more articulated carriage arms) to provide lateral stability (substantially horizontal, in use) to the elevator carriage, in particular to resist the force of the wind on the elevator carriage and any load that the elevator carriage carries (e.g. the carriage arms enables a reaction against such forces, as reaction arms).

The elevator carriage 140 may releasably connect onto two or three rails with the one or more carriage arms 146 each having a bearing assembly that receives a respective second tower rail 120B, 120B′, and enables the carriage arm to bear against the second tower rail.

Alternatively, the one or more carriage arms 146 of the elevator carriage 140 may bear against either or both of the exterior of the tower body 116 and one or two second tower rails 120B, 120B′.

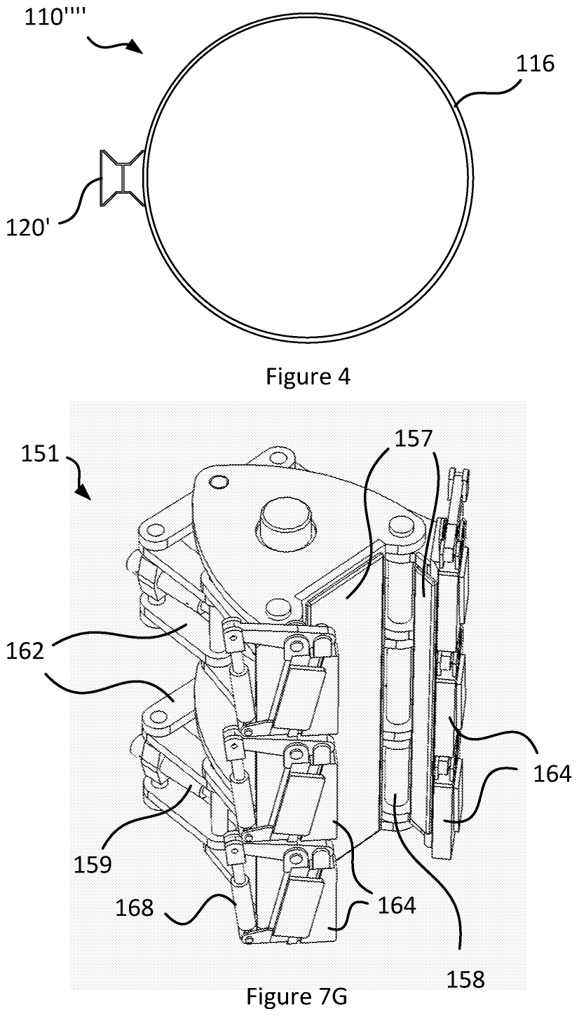

In the case that the elevator carriage releasably connects onto only one rail in use, the tower 110″″ may be provided with only a single rail 120′, as shown in the cross-sectional view of FIG. 4.

FIG. 5A illustrates the carriage chassis 142 of the elevator carriage 140 that connects onto the tower 110. As shown, the carriage chassis 142 has a carriage body 144 that releasably engages onto a first tower rail 120A, with one or more carriage arms 146 (e.g. one pair of carriage arms 146) that extend from the carriage body and which engage with second tower rails 120B. The carriage arms 146 may be extendible, to enable the carriage arms to engage with the second rails 120B at different heights up a wind turbine tower 110 that has a tapered tower body 116, or to enable use of the elevator carriage on towers that are differently sized or have differently spaced rails). By engagement with the second tower rails 120B, the carriage arm(s) 146 enable the carriage chassis 142 to resist lateral forces (generally horizontal forces), including the force of the wind upon both the elevator carriage 140 and any transported load.

The carriage chassis 142 may have a pair of opposed carriage arms 146, as shown in FIG. 5A. Alternatively, the carriage chassis may have only one carriage arm (not shown). In a further alternative, the carriage chassis 144′ may have more than two carriage arms 146, for example having an upper pair and lower pair of carriage arms, as shown in FIG. 5B. The use of more than one pair of carriage arms 146 enables the elevator carriage 140 to resist the lateral forces experienced by larger loads (e.g., larger tower sections and larger rotor-nacelle assemblies) and to distribute the forces across a larger area of the tower 116.

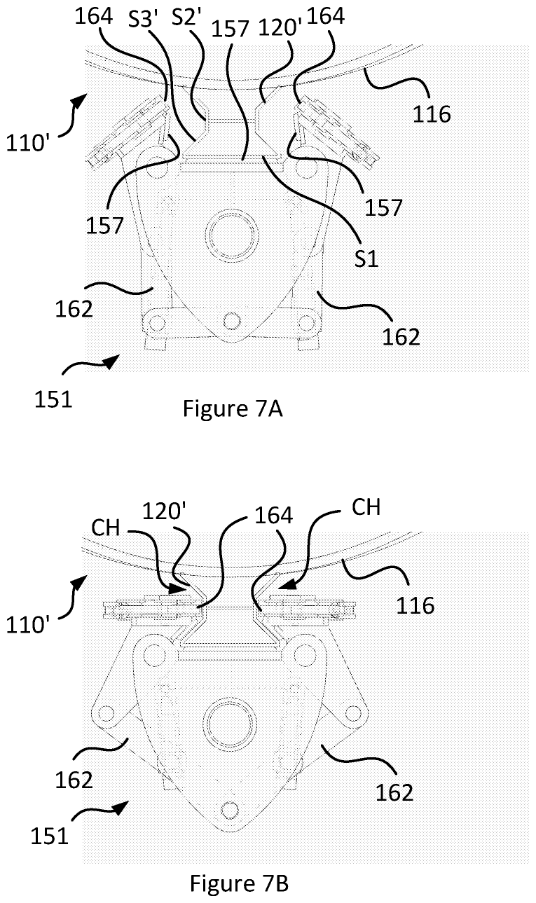

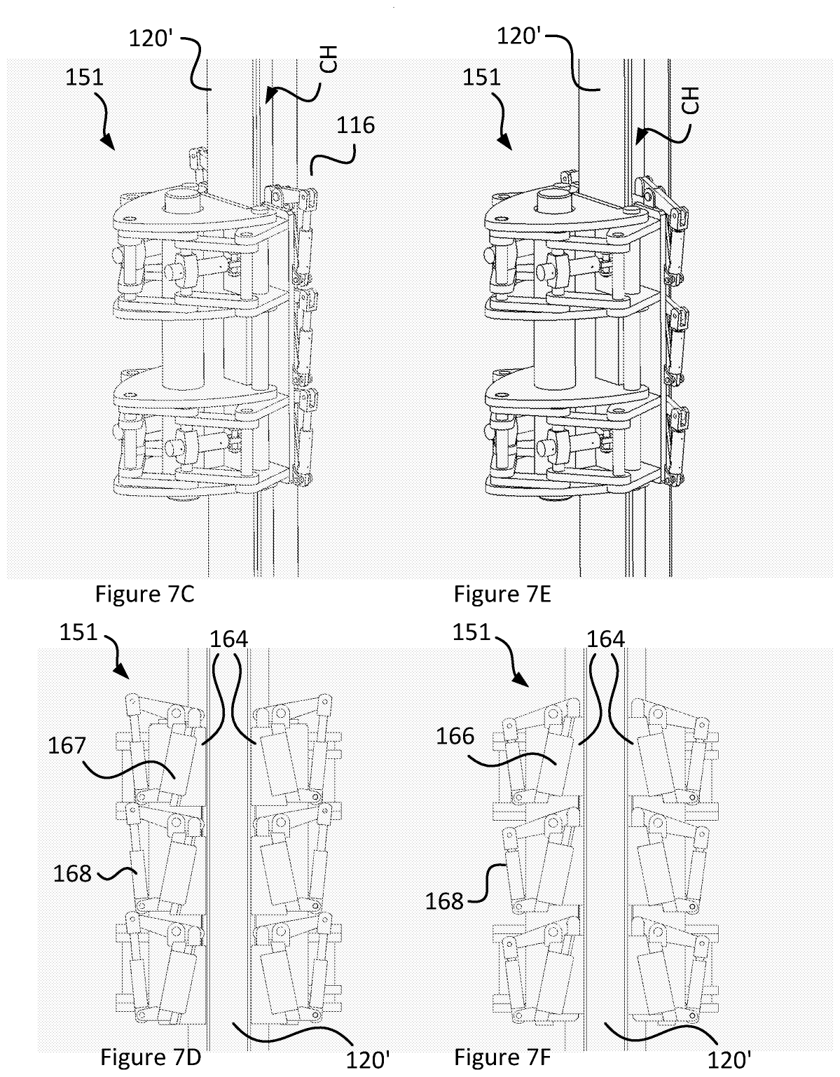

In each of FIGS. 5A and 5B, the carriage chassis 142, 142′ is provided with bearing assemblies 150 (e.g., sliding bearings, for releasably engaging with and sliding along a rail, in use) for stabilising the carriage chassis on the first tower rail 120A and at least one second tower rail 120B, and clamping mechanisms 160 for supporting the carriage chassis on the first rail 120A. The bearing assemblies and clamping mechanisms may be integrated into composite bearing clamping units 151 (150, 160, as shown in FIGS. 5C and 7A) providing both functions. In the arrangement of FIGS. 5A and 5B, the bearing assemblies 150 (and optionally clamping mechanisms 160) provided on each carriage arm 146 releasably retain each second tower rail 120B within the respective bearing assembly (e.g. they extend around both sides of each second tower rail, enabling an opposed clamping action onto each second tower rail, similarly to a hand grasping with an opposed thumb and fingers, e.g. clamping in the opposed channels CN in the sides of each tower rail).

FIGS. 5C illustrates a further carriage chassis 142″ of the elevator carriage before releasable connection onto the tower. FIGS. 5D and 5E show the carriage chassis 142″ releasably connected onto the tower 110 in respective first and second configurations.

The carriage chassis 142″ has a composite bearing clamping unit 151 comprising a bearing assembly and a clamping mechanism (or alternatively has a separate bearing assembly 150 and clamping mechanism 160) for engaging with a first tower rail 120A. The carriage chassis 142″ has one or more carriage arms 146 that extend from the carriage body, and which are provided with further bearings 150B″, to resist lateral forces on the carriage chassis 142″.

FIG. 5D illustrates the carriage chassis 142″ connected to the tower in a first configuration, with the composite bearing clamping unit 151 connected onto the first tower rail 120A′, and with the further bearings 150B″ engaged against the tower body 116. The further bearings 150B″ are each provided with a first bearing member 148A for engaging against the tower body 116, e.g. the first bearing member 148A may be a bearing pad or a roller. In the case that the first bearing member 148A is a roller, it may be spherical to allow rolling in different directions, or may be shaped to complement the shape of the tower body, e.g., being generally cylindrical). The first bearing member 148A may be used to resist lateral forces on the carriage chassis 142″ when the second tower rails 120B′ are beyond the reach of the carriage arms 146″, for example on the lower portion of a tapered tower body 116, or where the carriage chassis is mounted onto a tower body without second tower rails 120B′.

FIG. 5E illustrates the carriage chassis 142″ connected to the tower in a second configuration, with the composite bearing clamping unit 151 connected onto the first tower rail 120A′, and with the further bearings 150B″ engaged against the second tower rails 120B′. The further bearings 150B″ are each provided with a second bearing member 148B for engaging against a second tower rail 120B′ (e.g., against a channel in the side of the second tower rail) by extension of the carriage arm 146″, e.g., the second bearing member 148B may be a bearing pad or a roller. In the case that the second bearing member 148B is a roller, it may be spherical to allow rolling in different directions, or may be shaped to complement the channel CH of the respective tower rail). The second bearing member 148B may be used to resist lateral forces on the carriage chassis 142″ when engaged with the second tower rails 120B′, for example on the upper portion of a tapered tower body 116 having second tower rails 120B′.

The further bearings 150B″ of the carriage chassis 142″ illustrated in FIGS. 5C to 5E are each provided with both a first bearing member 148A for engaging against (e.g. biasing against) the tower body 116, and a second bearing member 148B for engaging against a second tower rail 120B. However, alternatively, the further bearings may only be provided with the first bearing member 148A or the second bearing member 148B (e.g. only a spherical or generally cylindrical roller may be provided that may engage against either the tower body 116 or the second tower rail 120B′).

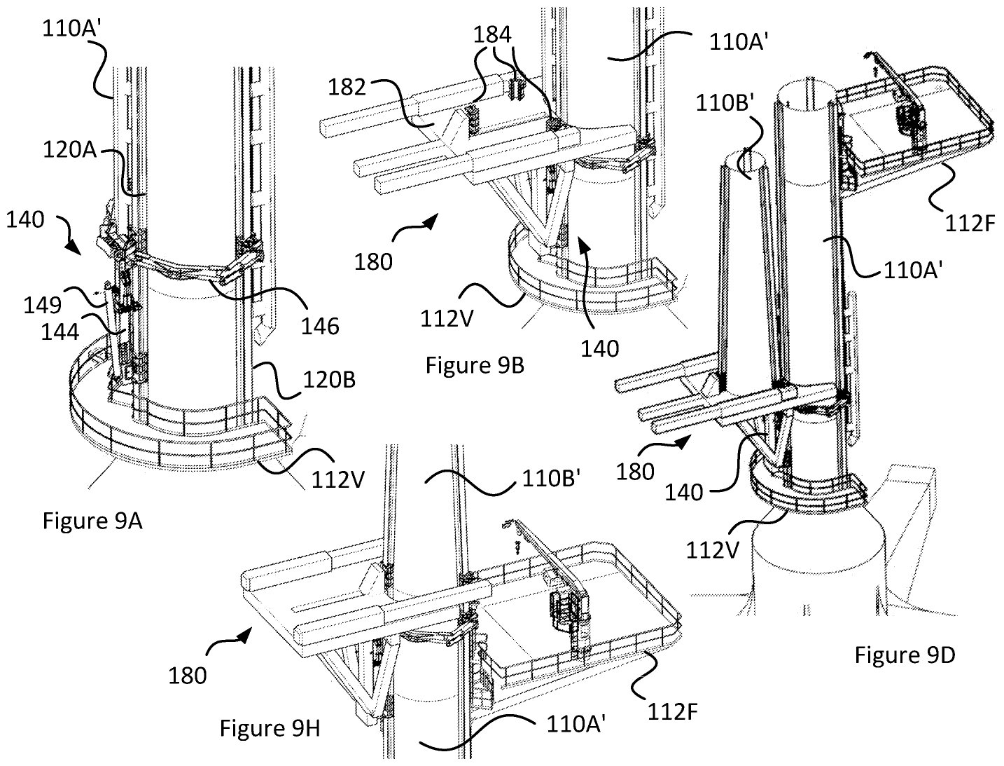

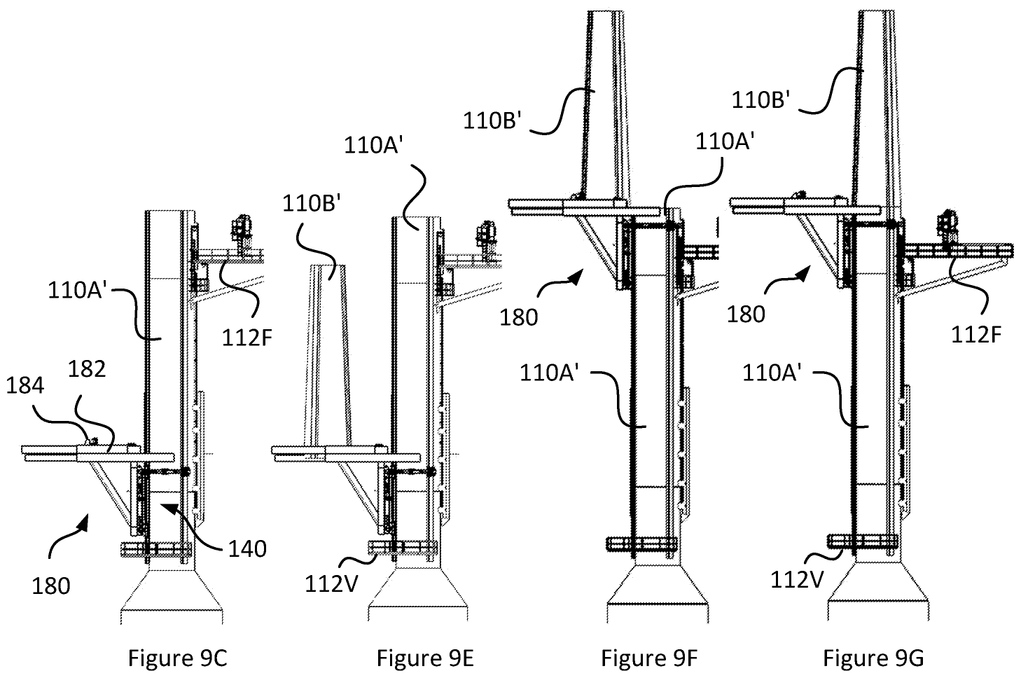

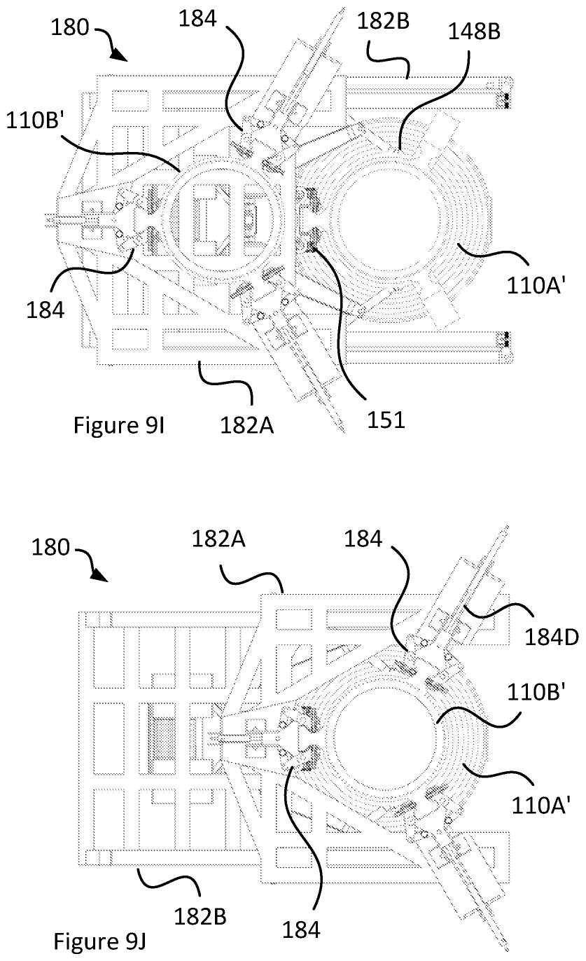

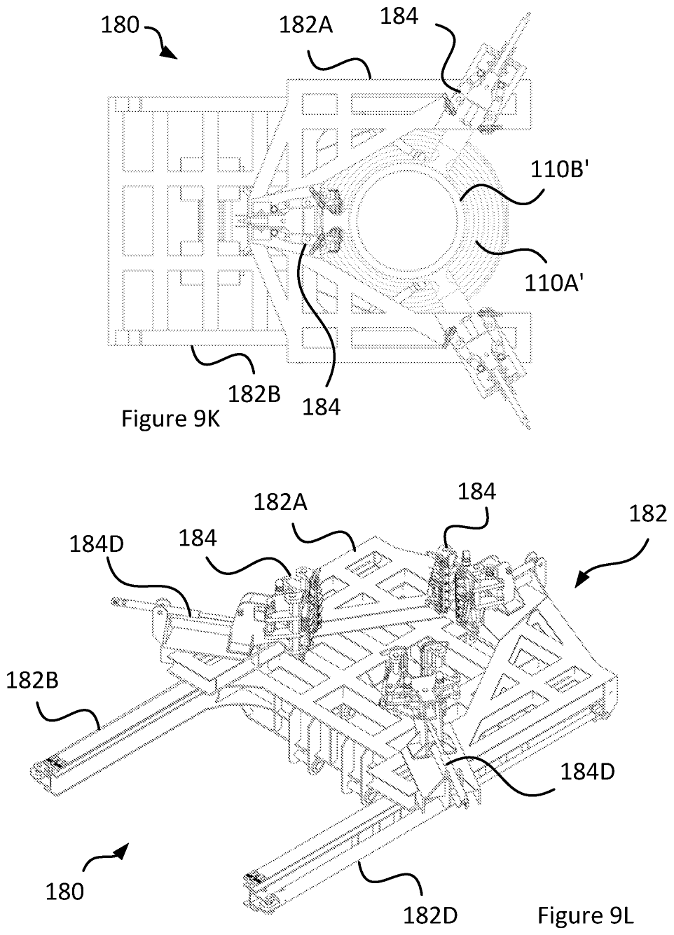

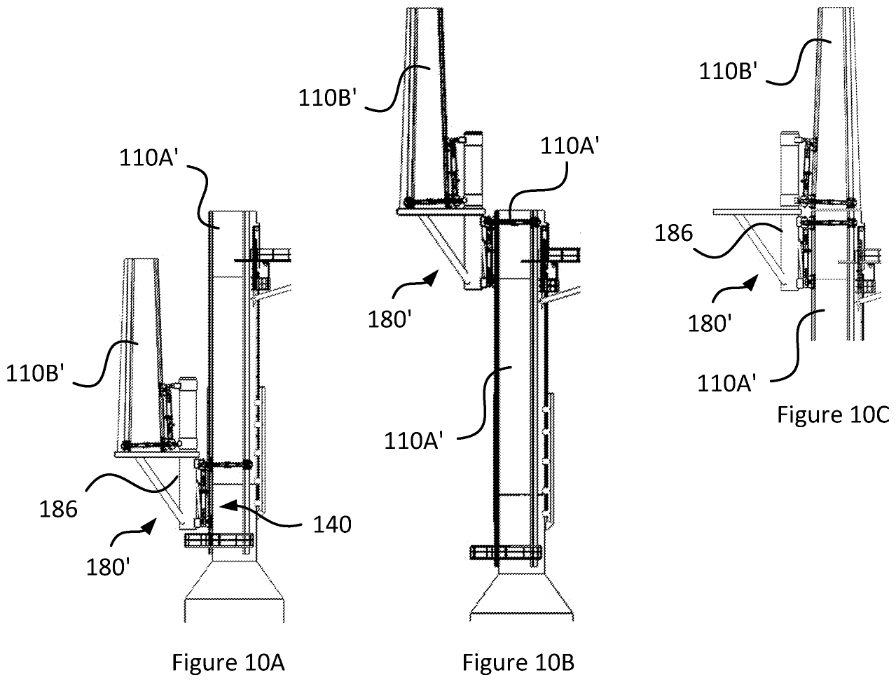

The elevator carriage 140 has a load-bearing part that is connected to the chassis body 144 by a lateral pivot mechanism 145, as shown in FIG. 5C (e.g., enabling pivoting of the load-bearing part about a generally vertical axis, in use). When in use to transport a load, the lateral pivot mechanism 145 enables the load to pivot with respect to the chassis body 144, being stabilised by the carriage arms 146, in use e.g. bearing upon second tower rails 120B, 120C as shown in FIG. 5E, or bearing upon the exterior of the tower body 116 as shown in FIG. 5D). The pivoting of the load with respect to the chassis body 144 enables the lateral torque on the elevator carriage 140 and on the load (e.g., a rotor-nacelle assembly 170, or a tower section 110′, as shown in FIGS. 9C to 10C), from the force of the wind, to be stabilised by a reactionary torque spread around the tower body 116 by the carriage arms 146, rather being concentrated only at the tower rail 120 on which the carriage body is mounted (e.g. first tower rail 120A).

FIGS. 5F shows a side view of the elevator carriage 140 clamped onto an erected tower section 110A′, and transporting a further tower section 110B′ on the tower section platform 182 of a carriage adaptor 180, which are discussed further in relation to FIGS. 9A to 9L. The carriage adaptor 180 is connected to the elevator carriage 140 with a carriage linkage 140L.

FIG. 5G shows a perspective view of the elevator carriage 140 of FIG. 5F. The elevator carriage 140 has a carriage body 144 with composite bearing clamping units 151 for releasably clamping onto a first rail 120A of the wind turbine tower 110, and carriage arms 146 provided with further bearings 150B″, to resist lateral forces, which support a bearing member 148A (e.g., a roller). The carriage body 144 is provided with sliding bearing pads 140B for engagement against the outer face S1 of the first rail 120A. The elevator carriage 140 may be provided with a carriage access platform 140P.

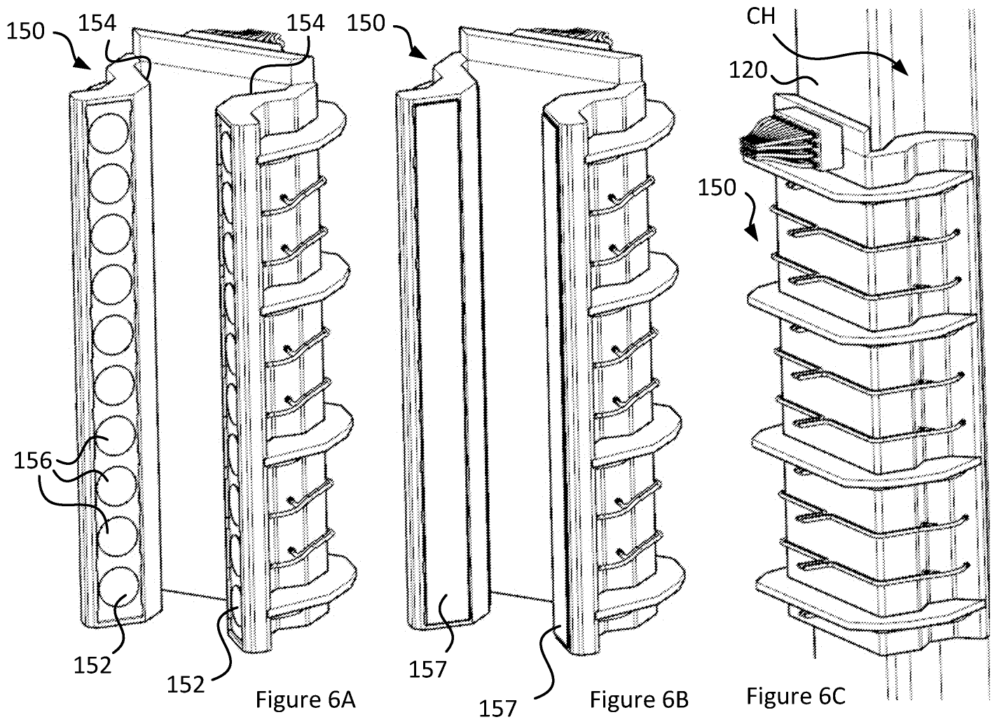

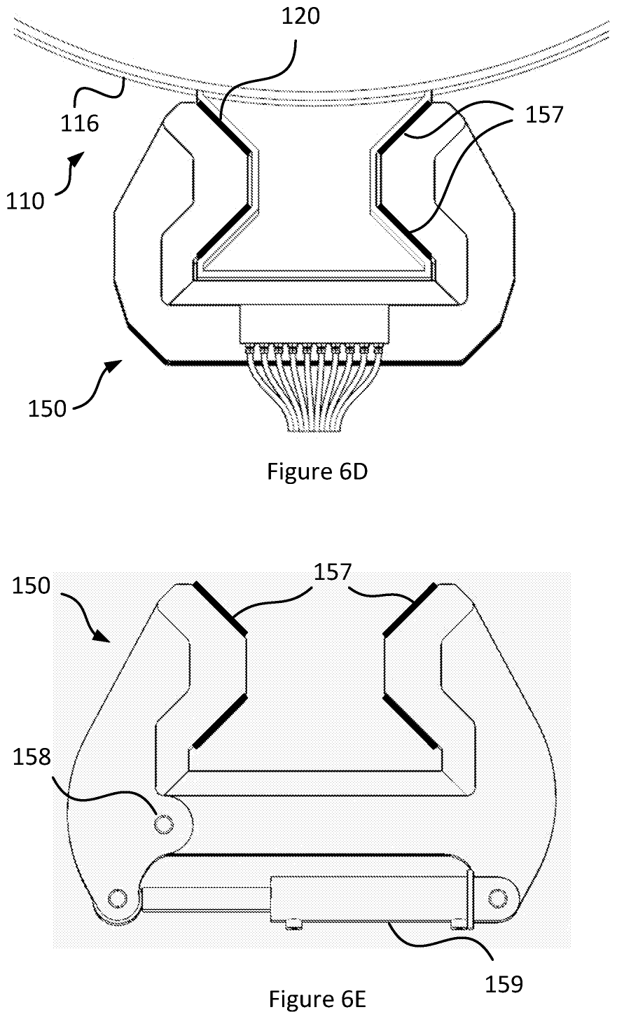

FIGS. 6A to 6E show a bearing assembly 150 for releasably engaging with a rail 120 and for sliding along the rail, in use. The bearing assembly 150 has first sliding bearing faces 152 for engaging with the first side bearing faces S3 of the rail 120, and second sliding bearing faces 154 for engaging with the second side bearing faces S4 of the rail. Each sliding bearing face 152, 154 is configurable to enter into engagement with an underlying face S3, S4 of the rail, in use, for example being provided with one or more hydraulically operated bearing face pistons 156. The hydraulically operated engagement mechanism 156 (e.g. pistons) may be covered with a protective cover 157, as shown in FIG. 6B. The bearing assembly 150 is provided with a pivotable opening linkage 158, which may be operated by a hydraulic closure piston 159. The pivotable linkage 158 enables the bearing assembly 150 to open, to be received onto the rail 120, and then to close around the rail with a small clearance, to allow the bearing assembly to slide along the rail without disengagement from the rail. The (optional) hydraulically operated bearing face pistons 156 (or other hydraulically operated engagement mechanism) may be operated to grasp the rail 120 for additional stabilisation, when the bearing assembly 150 is not sliding along the rail.

Alternatively, the bearing assembly and clamping mechanisms may be integrated into composite bearing clamping units 151 providing both functions. FIGS. 7A to 7G show the composite bearing clamping units 151. The composite bearing clamping units 151 have opposed articulated self-locking arms 162 (clamp arms configured for retaining the clamp arm in a clamped position, in use) supporting clamping pads 164, 164.

FIGS. 7A and 7G show the composite bearing clamping units 151 in the fully open configuration, with both self-locking arms 162 widely open, to enable the clamping mechanism to be engaged with (or disengaged from) the rail 120′.

FIGS. 7B, 7C and 7D show the composite bearing clamping units 151 closed around the rail 120′, in a closed configuration, in which the self-locking arms 162 are closed into a self-locked position, with clamping pads 164 loosely contacting, or close to, the clamping faces S2 of the rail, with the clamping pads projecting into the channels CH, and the composite bearing clamping unit is retained on the rail.

FIGS. 7E and 7F show the composite bearing clamping units 151 in a closed and locked configuration, with the clamping pads 164 firmly clamped onto the rail 120′, clamped onto the clamping faces S2. The composite bearing clamping units 151 are firmly clamped onto the rail 120′ by a hydraulic mechanism 168. In the illustrated composite bearing clamping unit 151, the clamping pads 164 are wedge-shaped and slideable in a complementarily-shaped shoe 166. By operation of the hydraulic clamping mechanism 168, the wedge-shaped clamping pads 164 are slid along the shoe (close to the direction of the length of the rail 120′), wedging them firmly against the rail, causing the composite bearing clamping units 151 to be firmly, releasably clamped onto the rail. The wedge-like arrangement of clamping pads 164 that can slide relative to a complementarily-shaped shoe that is rigidly held in the composite bearing clamping unit 151 (e.g., by a self-locking arm, or an alternative rigid mechanism) enables the rail 120 to be clamped sufficiently firmly that the traction (static friction and sheer force arising from any mechanical deformation of the surface) arising enables the clamping mechanism to support a very high mass, for example each composite bearing clamping unit 151 may support a mass of at least 10 ton (e.g., at least 30 ton) in the fully clamped position, on a generally vertical rail.

The composite bearing clamping unit 151 has been illustrated in FIG. 7D as being formed with wedge-shaped clamping pads 164 and complementarily-shaped shoes 166. However, alternatively, the clamping mechanism may be formed by a cam cleat mechanism that automatically locks onto the rail under downward movement (with a controllable over-ride, to allow descent of the rail).

Each composite bearing clamping unit 151 may be formed as a series of corresponding composite bearing clamping modules, with the number of composite bearing clamping modules being at least sufficient to enable the clamping mechanism to support both the rotor-nacelle assembly and the carriage elevator 140, in use. Similarly, where separate bearing assembly 150 and clamping mechanisms 160 are used, each clamping mechanism may be formed as a series of clamping modules, with the number of clamping modules being at least sufficient to enable toe clamping mechanism to support the rotor-nacelle assembly and the elevator carriage 140, in use.

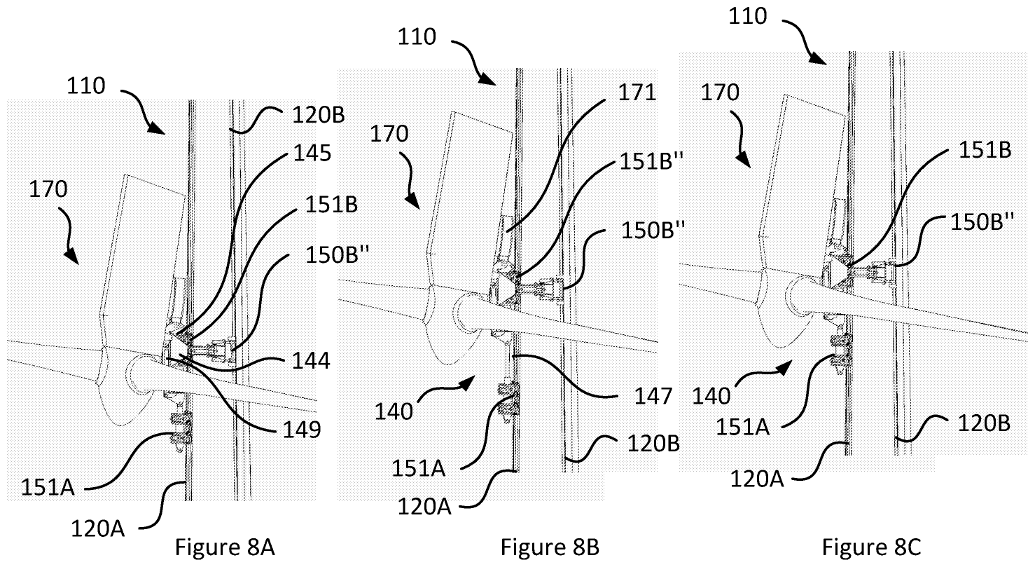

FIGS. 8A to 8C illustrate jacking of elevator carriage 140 up the wind turbine tower 110. The carriage chassis 142 of the elevator carriage 140 has a lower composite bearing clamping unit 151A, and an upper composite bearing clamping unit 151B. The lower composite bearing clamping unit 151A forms a lower sub-assembly that is slideable, along the rail 120A on which the elevator carriage 140 is mounted, relative to an upper sub-assembly having the upper composite bearing clamping unit 151B and the chassis body 144, with the relative movement driven by a jacking ram 147.

In FIG. 8A, the lower composite bearing clamping unit 151A is closed and clamped upon the rail 120A. The jacking ram 147 is extended, which lifts the carriage body 144 (and the remainder of the elevator carriage 140) up the rail 120A to the position shown in FIG. 8B. Then the upper composite bearing clamping unit 151B is closed and clamped upon the rail 120A. Then the lower composite bearing clamping unit 151A is released into a slideably engaged but unclamped configuration. Then the jacking ram 147 is drawn-in to raise the lower composite bearing clamping unit 151A, as shown in FIG. 8C. By repeating this sequence, the elevator carriage 140 and any load (e.g., a rotor-nacelle assembly 170) can be raised up the tower 110. By reversing this sequence, the elevator carriage 140 and any load can be lowered down the tower 110.

The elevator carriage 140 is provided with a nacelle pivoting ram 149, with which the rotor-nacelle assembly 170 may be pivoted, when the carriage has travelled to the top of the tower 110, being pivoted from the elevation orientation (e.g. with the rotor rotation axis orientated generally downwardly, e.g. generally vertically downward, as per FIGS. 8A to 8C) in which the elevator carriage 140 supports the rotor-nacelle assembly during transport up the side of the tower, to the operational orientation (e.g. with the rotor rotation axis orientated horizontally) that enables the nacelle to be connected to the top of the tower (e.g. with a yaw bearing enabling the nacelle to yaw relative to the tower).

The one or more rails may be provided on a single-section tower body. However, for large wind turbine assemblies, the tower 110 may be formed from multiple tower sections 110′, as shown in FIG. 1. The tower sections 110′ are connected together during assembly, e.g. by connection bolts 115, as shown in FIG. 2A. The sections of adjacent tower body are connected together, and the adjacent sections of rail may also be connected together.

FIGS. 9A to 9K show steps in a method of assembly the of the wind turbine tower 110.

In FIG. 9A, the elevator carriage 140 is shown with the carriage body 144 releasably connected to a first rail 120A of an erected tower section 110A′, with carriage arms 146 releasably connected to (e.g. bearing against) the second rails 120B.

FIGS. 9B and 9C show a carriage adaptor 180 (tower section support) connected to the elevator carriage 140, and FIG. 9L shows a perspective view of the carriage adaptor 180. (The connection between the carriage adaptor 180 and the elevator carriage 140 is shown further in FIG. 5F). The carriage adaptor 180 is adapted to support a tower section 110B′ during transport up or down the erected tower section(s) 110A′ by the elevator carriage 140. The carriage adaptor 180 has a tower section support platform 182 for receiving the tower section 110B′ to be transported. Clamping mechanisms 184 (securing mechanisms) are provided on the carriage adaptor 180 (e.g. on the tower section support platform 182) for securing (stabilising) the tower section 110B′ on the carriage adaptor. The clamping mechanisms 184 on the carriage adaptor 180 secures the tower section 110B′ by traction (static friction and resistance to sheering arising from any mechanical deformation of the clamped surfaces). The carriage adaptor 180 may be resizable to enable differently sized tower sections 110B′ to be transported (e.g., resizable to secure tower sections having different base diameters, as one or more upper tower sections may have a smaller diameter than one or more lower sections).

The tower section 110B′ to be transported is then loaded onto the tower section support platform 182 of the carriage adaptor 180, as shown in FIGS. 9D and 9E. The tower section 110B′ may rest upon the tower section support platform 182, which may assist with registration of height of the tower section 110B′. The clamping mechanisms 184 are moved into position (e.g., by clamp alignment drives 184D), and clamped onto the rails 120 of the tower section 110B′, to secure the tower section on the carriage adaptor 180.

The elevator carriage 140 is then raised up to the top of the erected tower section(s) 110A′, e.g. with the bottom of the transported tower section 110B′ slightly above the top of the erected tower sections, as shown in a side view in FIG. 9F, and in a plan view in FIG. 9I.

As shown in FIG. 9L, the tower section support platform 182 may have a platform upper section 182A for receiving a tower section 110B′ to be transported, which is slideably engaged on a platform lower section 182B that is connected to the elevator carriage 140. Sliding movement of the platform upper section 182A relative to the platform lower section 182B is provided by a platform drive mechanism 182D (e.g. a hydraulically operated piston).

The carriage adaptor 180 then slides the transported tower section 110B′ across to the top of the erected tower section(s) 110A′, by sliding the platform upper section 182A relative to the platform lower section 182B, e.g. sliding the transported tower section into a coaxial alignment with the erected tower section(s), as shown in FIGS. 9G and 9J.

The carriage adaptor 180, which is connected to the elevator carriage 140, is then lowered (e.g. by lowering the elevator carriage) until the transported tower section 110B′ rests on the erected tower section(s) 110A′, as shown in perspective view in FIG. 9H. The transported tower section 110B′ is then connected to the top of the erected tower section(s) 110A′, for example by being bolted together (e.g. with connection bolts 115, similarly to those shown in FIG. 2A. Once the transported tower section 110B′ has been connected into the wind turbine tower 110, the carriage adaptor 180 releases the clamping mechanisms 184 from transported tower section 110B′ as shown in FIG. 9K, and the platform upper section 182A may then be drawn back from the wind turbine tower 110.

The tower 110 may be disassembled by following a reverse sequence to the assembly of the tower.

FIGS. 10A to 10C show sequential steps in an alternative method of assembly of the wind turbine tower 110 using an alternative carriage adaptor 180′. Similarly to FIGS. 9A to 9H, the carriage adaptor 180′ is adapted to support a tower section 110B′ during transport up or down the erected tower section(s) 110A′ by the elevator carriage 140. The carriage adaptor 180′ differs from the carriage adaptor 180 of FIG. 9A by having a tower section pivoting mechanism 186 for pivoting the tower section 110B′ being transported.

As with the previous method, the tower section 110B′ to be transported is loaded onto the carriage adaptor 180′, as shown in FIG. 10A, before the elevator carriage 140 is raised up to the top of the erected tower section(s) 110A′, e.g. with the bottom of the transported tower section 110B′ slightly above the top of the erected tower sections, as shown in FIG. 10B.

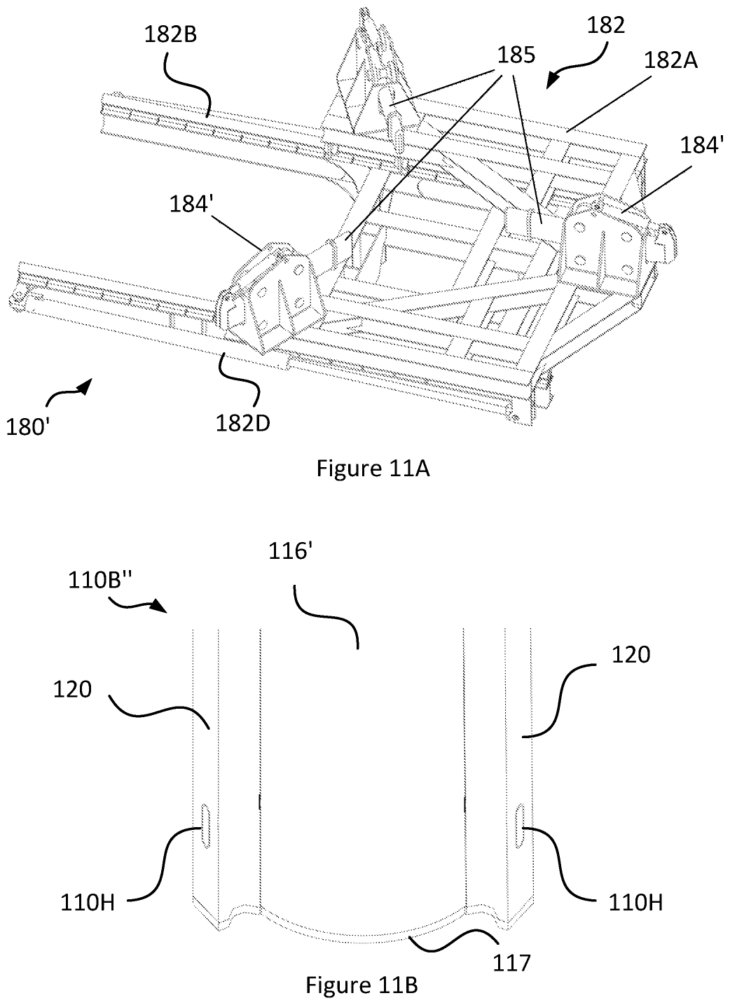

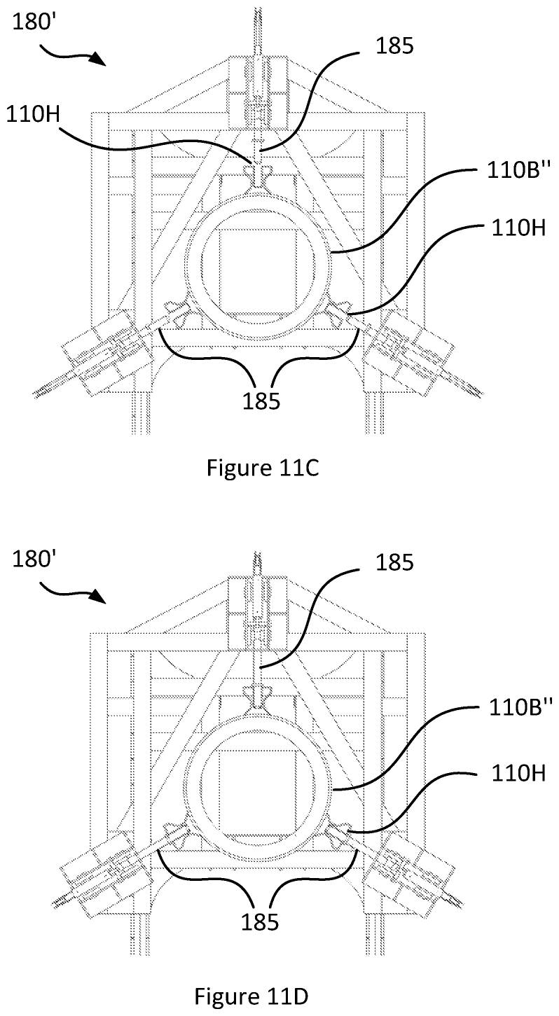

The tower section pivoting mechanism 186 of the carriage adaptor 180′ then pivots the transported tower section 110B′ around a vertical axis to align (e.g. coaxially) the transported tower section 110B′ above the top of the erected tower section(s) 110A′, as shown in FIG. 10C. The elevator carriage 140 is then lowered until the transported tower section 110B′ rests on the erected tower section(s) 110A′. The transported tower section 110B′ is then connected to the erected tower section(s) 110A′, for example by being bolted together. Pivoting the transported tower section 110B′ into alignment, as shown in FIGS. 10B and 11C, may be mechanically less complex than sliding the transported tower section, as shown in FIGS. 9F to 9H.

FIGS. 9B and 9C show a carriage adaptor 180 connected to the elevator carriage 140, having clamping mechanisms 184 for securing to the transported tower section 110B′ by traction (static friction and resistance to sheer forces arising from any mechanical deformation of the clamped surface). FIGS. 11A to 11D show an alternative system for securing transported tower sections 110B″ to a carriage adaptor 180′, which differs in that the securing mechanisms 184′ are provided extendible securing pins 185 for securing to the transported tower section 110B′ by mechanical engagement into complementary pin receiving formations (holes) 110H in the tower section 110B″. The pin receiving formations 110H are provided proximate the base 117 of the tower section 110B″. The pin receiving formations 110H may be provided in the rails 120, which may enable better distribution of forces across the body 116′ of the tower section 110B″ that arise during use. The carriage adaptor 180′ may be resizable to enable differently sized tower sections 110B″ to be transported.

FIG. 11C and 11D respectively show, in plan view, a tower section 110B″ received onto tower section support platform 182 of the carriage adaptor 180′ before and after the securing pins 185 have been extended into the pin receiving formations 110H to secure the tower section 110B″ for transport by the elevator carriage 140.

The securing pins 185 may be moved between the extended and retracted positions by respective actuation mechanisms.

As shown in FIGS. 9F and 9G, once the tower section 110B″ has been raised into position by the elevator carriage 140, the tower section 110B″ slides across to the top of the erected tower section(s) 110A. As shown in FIG. 11A, the tower section support platform 182 may have a platform upper section 182A that is slideably engaged on a platform lower section 182B that is connected to the elevator carriage 140. Sliding movement of the platform upper section 182A relative to the platform lower section 182B is provided by a platform drive mechanism 182D (e.g., a hydraulically operated piston).

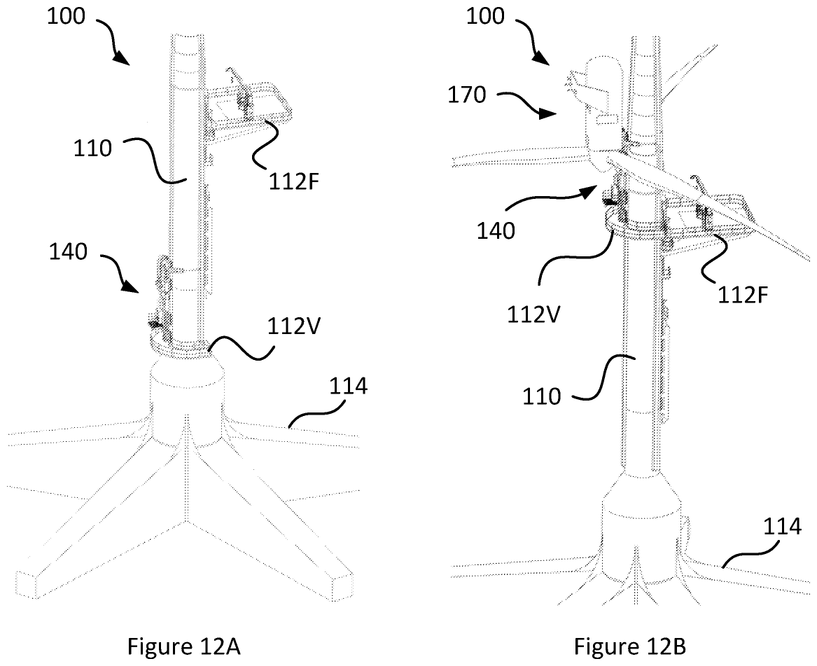

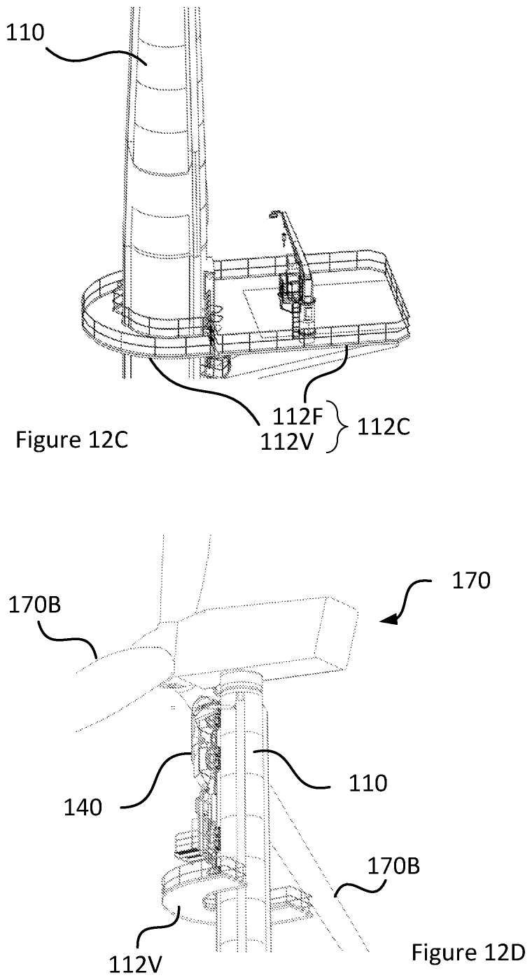

As shown in FIG. 9D, the wind turbine tower 110 may be provided with a fixed-level access platform 112F. Additionally, the wind turbine tower 110 may be provide with a variable-level access platform 112V as shown in FIGS. 12A to 12D.

As shown in FIGS. 12B and 12C, the variable-level access platform 112V may be aligned with the fixed-level access platform 112F to provide a composite access platform assembly 112C that provides an access platform around the wind turbine tower 110. By extending completely around the wind turbine tower 110, the composite access platform assembly 112C forms a safety platform that would enable a worker to abseil down the exterior of the wind turbine tower in any position around the wind turbine tower (e.g., enabling abseiling from the nacelle, on top of the wind turbine tower, in the event of an emergency evacuation, irrespective of the yaw direction of the nacelle).

As shown in FIGS. 9D, 10A and 12A, the provision of an access platform that extends completely around the wind turbine tower 110 as a composite access platform assembly 112C with a variable-level access platform 112V, enables movement of the elevator carriage 140 up and down the wind turbine tower 110 during construction (or disassembly) of the wind turbine 100. The variable-level access platform 112V may be left at or close to the bottom of the wind turbine tower 110 during construction (e.g. clamped to the rails 120), or the variable-level access platform 112V may remain connected to elevator carriage 140 (e.g. to facilitate worker access to the elevator carriage).

The variable-level access platform may be mounted onto the bottom section 110A′ of the wind turbine tower 110 before completing assembly of the wind turbine tower 110, as shown in FIG. 9C. For example, both the fixed-level access platform 112F and the variable-level access platform 112V may be mounted onto a floating foundation 114 on-land or at the quay-side, before the floating foundation travels to the installation site.

Once the wind turbine tower 110 has been assembled, the variable-level access platform 112V may be connected beneath the elevator carriage 140 and raised level with the fixed-level access platform 112F (e.g. providing a level walkway for workers), either in a dedicated method step, or when raising the rotor-nacelle assembly 170 for mounting onto of the wind turbine tower, as shown in FIG. 12B. Then the variable-level access platform 112V may be mounted in position by securing to the rails (e.g., by clamping), by bolting or otherwise connecting to the wind turbine tower 110, or may be bolted or otherwise connected to the fixed-level access platform 112F (or by a combination of such mounting methods). Raising the variable-level access platform 112V with the elevator carriage 140 enables the variable-level access platform to have low complexity, without the requirement for a separate drive mechanism.

After the variable-level access platform 112V has been mounted level with the fixed-level access platform 112F, the elevator carriage 140 may be disconnected from the variable-level access platform 112V. The elevator carriage 140 may then continue up the wind turbine tower 110 with a load (e.g. the rotor-nacelle assembly 170 or a tower section 110′), or where the elevator carriage is not carrying a load, the elevator carriage may be removed from the wind turbine tower (e.g., by a crane, or by an alternative mechanism for transferring the elevator carriage to a marine vessel). Similarly, the elevator carriage 140 may be used to lower the variable-level access platform 112V beneath the level of the fixed-level access platform 112F.

The variable-level access platform 112V may also be raised further up the wind turbine tower 110 by the elevator carriage 140, to facilitate high-level access by a worker, as shown in FIG. 12D. For example the raised variable-level access platform 112V may enable inspection or maintenance access to a wind turbine blade 170B when the blade is turned to a downwardly-extending position.

Alternatively (or additionally) to the variable-level access platform 112V being raised and lowered by the elevator carriage 140, the variable-level access platform may be provided with a platform drive mechanism engaged with one or more rails 120 of the wind turbine tower 110, and enabling the variable-level access platform to be raised and lowered independently. The provision of a platform drive mechanism enables the elevator carriage 140 to be removed from the wind turbine tower 110 before the variable-level access platform is moved level with the fixed-level access platform 112F, enabling the elevator carriage to be removed from a lower position on the side of the wind turbine tower, enabling it to be more easily removed (e.g., enabling removal with a smaller crane, or by transfer to a marine vessel without the use of a crane). Independent movement of the variable-level access platform 112V also enables the variable-level access platform to be moved to different heights without requiring the elevator carriage to be present on the wind turbine tower.

Alternatively, the variable-level access platform 112V may be raised and lowered by a winch mechanism, e.g. a winch mechanism engaging with or mounted on the fixed-level access platform 112F.

Although construction and assembly of the wind turbine assembly has been illustrated with an offshore floating foundation, the construction and assembly may also be used for onshore wind turbine assemblies, e.g. with solid foundations in the ground.

The figures provided herein are schematic and not to scale.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, and characteristics, described in conjunction with a particular aspect, embodiment or example of the disclosure are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The disclosure is not restricted to the details of any foregoing examples. The disclosure extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification.

1-43. (canceled)

44. A wind turbine tower elevator carriage comprising:
a carriage body;
a lifting mechanism for raising and lowering the carriage body on a wind turbine tower; and
a carriage arm connected to the carriage body, wherein the carriage arm comprises a lateral bearing assembly and a bearing arm actuator for engaging the lateral bearing assembly with a first tower rail of the wind turbine tower.

45. The wind turbine tower elevator carriage according to claim 44, wherein the lateral bearing assembly is configured to receive a second tower rail of the wind turbine tower into the lateral bearing assembly.

46. The wind turbine tower elevator carriage according to claim 45, wherein the lateral bearing assembly comprises a sliding bearing.

47. The wind turbine tower elevator carriage according to claim 45, wherein the lateral bearing assembly comprises a clamping mechanism.

48. The wind turbine tower elevator carriage according to claim 45, wherein the lateral bearing assembly comprises a sliding bearing and a clamping mechanism.

49. The wind turbine tower elevator carriage according to claim 45, wherein the lateral bearing assembly is configured to releasably receive the second tower rail.

50. The wind turbine tower elevator carriage according to claim 44, wherein the lateral bearing assembly comprises a first bearing member for engaging against a side of a second tower rail of the wind turbine tower.

51. The wind turbine tower elevator carriage according to claim 50, wherein the first bearing member is a bearing pad or a roller.

52. The wind turbine tower elevator carriage according to claim 44, wherein the lateral bearing assembly comprises a second bearing member for engaging with an exterior surface of a tower body of the wind turbine tower.

53. The wind turbine tower elevator carriage according to claim 52, wherein the second bearing member is a bearing pad or a roller.

54. The wind turbine tower elevator carriage according to claim 44, wherein the carriage arm comprises one or more extendible arm members for changing a separation between the carriage body and the lateral bearing assembly.

55. The wind turbine tower elevator carriage according to claim 44, wherein the wind turbine tower elevator carriage comprises opposed carriage arms.

56. The wind turbine tower elevator carriage according to claim 44, further comprising:
a load-bearing part; and
a pivot mechanism for pivoting the carriage body with respect to the load-bearing part about a substantially vertical axis when the wind turbine tower elevator carriage is mounted onto a side of the wind turbine tower.

57. The wind turbine tower elevator carriage according to claim 56, wherein the load-bearing part is a clamping mechanism.

58. The wind turbine tower elevator carriage according to claim 44, further comprising:
independently operable first and second releasable rail clamps; and
a lifting mechanism for raising and lowering the carriage body with respect to the first releasable rail clamp.
